(19) United States
(12) Patent Application Publication
(10) Pub. No.: US 2002/0157551 A1
(43) Pub. Date: Oct. 31, 2002

(54) Plate-making method and plate-making apparatus

(75) Inventors: Sadao Ohsawa, Shizuoka (JP); Yusuke Nakazawa, Shizuoka (JP); Mutsumi Naniwa, Shizuoka (JP)

Correspondence Address: SUGHRUE MION PLLC, 2100 Pennsylvania Avenue, NW, Washington, DC, 20037-3213, US

(73) Assignee: FUJI PHOTO FILM CO., LTD.

(21) Appl. No.: 10/093,606

(22) Filed: Mar. 11, 2002

(30) Foreign Application Priority Data
Mar. 12, 2001 (JP) P. 2001-068852
Mar. 21, 2001 (JP) P. 2001-080721

(51) Int. Cl. B41F 1/18; B41N 3/00

(52) U.S. Cl. 101/463.1; 101/450.1

(57) ABSTRACT

A plate-making method comprising: forming an image directly on a plate material by an ink jet process of ejecting an oil ink using an electrostatic field based on signals of image data; and fixing the image to prepare a printing plate, wherein prevention of coagulation and/or precipitation of the oil ink particles is performed at least in a circulation of the oil ink, and an on-press drawing lithographic printing method comprising: attaching a plate material onto a plate cylinder of a press; forming an image directly on the plate material by an ink jet process of ejecting an oil ink from a recording head using an electrostatic field based on signals of image data to prepare a printing plate; and performing lithographic printing using the printing plate in that state, wherein prevention of coagulation and/or precipitation of the oil ink particles is performed at least in a circulation of the oil ink.

### FIELD OF THE INVENTION

In the first embodiment, the present invention relates to a plate-making method and a plate-making apparatus, which perform digital plate-making, more specifically, the present invention relates to a plate-making method and a plate-making apparatus, where an oil ink is used and good image quality can be attained in the plate-making and in the printing.

In the second embodiment, the present invention relates to an on-press drawing lithographic printing method and an on-press drawing lithographic printing apparatus, which perform the digital plate-making using an oil ink and subsequently perform printing on a press, more specifically, the present invention relates to an on-press drawing lithographic printing method and an on-press drawing lithographic printing apparatus, where oil ink particles are prevented from coagulation/precipitation and thereby, good image quality can be attained in the plate-making and in the printing.

### BACKGROUND OF THE INVENTION

In the lithographic printing, the printing is performed by forming an ink-receptive region and an ink-repulsive region on the surface of a printing plate in correspondence to an image original and adhering a printing ink to the ink-receptive region. Usually, hydrophilic and lipophilic (ink-receptive) regions are imagewise formed on the surface of a printing plate and the hydrophilic region is rendered ink-repulsive using a fountain solution.

In general, the recording of an image on a printing plate precursor (plate-making) is performed by a method of once outputting an image original on a silver salt photographic film in an analog or digital manner, exposing a diazo resin or photopolymerizable photopolymer light-sensitive material through the film and then, dissolving and removing the non-image area using an alkaline solution.

In recent years, the lithographic printing method is demanded to meet requirements for more improvement in the digital drawing technique and higher efficiency in the process and for satisfying these requirements, a large number of systems for directly drawing digital image information on a plate material have been proposed. These techniques are called CTP (computer-to-plate) or DDPP (digital direct printing plate). With respect to the plate-making method, for example, a system of recording an image in the light or heat mode using a laser has been proposed and this system is partially put into practical use.

However, in this plate-making method, irrespective of light mode or heat mode, the plate-making generally involves a treatment with an alkaline developer after the laser recording to dissolve and remove the non-image area and therefore, an alkaline waste solution is discharged. This is not preferred in view of the environmental conservation.

For realizing an efficient printing process, a system of performing the image drawing on a press is known and in this respect, the above-described method using a laser may be employed, but an expensive and large-scale apparatus is necessary. To overcome this problem, a system where an ink jet process using an inexpensive and compact recording device is applied has been proposed.

JP-A-4-97848 (the term “JP-A” as used herein means an “unexamined published Japanese patent application”) discloses a method of providing a plate drum having a hydrophilic or lipophilic surface part in place of the conventional plate cylinder, forming thereon a lipophilic or hydrophilic image by an ink jet process, removing and cleaning the image after the completion of printing. In this method, however, it is difficult to attain easy removal (namely, cleaning) of the printing image and a sufficiently long press life at the same time. In the case of forming a printing image having a sufficiently long press life on a plate cylinder, an ink containing a resin in a relatively high concentration must be used and accompanying the evaporation of solvent at the nozzle part, the resin readily fixes to the ink jet means for forming a printing image, as a result, the ink ejection stability decreases and a good image can be hardly obtained.

JP-A-64-27953 discloses a method of drawing an image on a hydrophilic plate material by an ink jet process using a lipophilic wax ink, thereby performing the plate-making. In this method, the image is formed by a wax and therefore, the image area is weak in the mechanical strength and deficient in the adhesive property to the hydrophilic surface of the plate material, which gives rise to poor press life.

In the case of drawing an image by an ink jet process, aggregates or foreign matters such as dust in the ink fed to the recording head which ejects ink cause clogging or the like of the head and this gives rise to unstable ejection of ink and in turn, deterioration in the image quality or moreover, stopping of the ejection. The present invention has been made to overcome these problems.

### SUMMARY OF THE INVENTION

A first object of the present invention is to provide a plate-making method and a plate-making apparatus, which can respond to a digital processing dispensable with development, where a lithographic printing plate capable of creating a large number of printed matters having a clear and high-quality image can be manufactured by an inexpensive and simple method.

A second object of the present invention is to provide an on-press drawing lithographic printing method and an on-press drawing lithographic printing apparatus, which can respond to a digital processing dispensable with development, where coagulation and/or precipitation of the oil ink particles are prevented.

A third object of the present invention is to provide an on-press drawing lithographic printing method and an on-press drawing lithographic printing apparatus, which can respond to a digital processing dispensable with development, where a large number of printed matters having a clear and high-quality image can be printed by an inexpensive apparatus and a simple and easy method.

By these methods and apparatuses, clogging of recording head, unstable ink ejection and deterioration in the quality of image drawn can be prevented.

These objects of the present invention can be attained by the following methods and apparatuses.

(1) A plate-making method comprising forming an image directly on a plate material by an ink jet process of ejecting an oil ink using an electrostatic field based on signals of image data, and fixing the image to prepare a printing plate, wherein prevention of coagulation and/or precipitation of the oil ink particles is performed at least in the circulation of ink.

(2) An on-press drawing lithographic printing method comprising attaching a plate material onto a plate cylinder of a press, forming an image directly on the plate material by an ink jet process of ejecting an oil ink from a recording head using an electrostatic field based on signals of image data to prepare a printing plate, and performing lithographic printing using the printing plate in that state, wherein prevention of coagulation and/or precipitation of the oil ink particles is performed at least in the circulation of ink

(3) The plate-making method as described in (1) above, wherein the oil ink is obtained by dispersing resin particles in a nonaqueous solvent having an electric resistivity of 10⁹ Ωcm or more and a dielectric constant of 3.5 or less and the resin particles are solid and hydrophobic at least at an ordinary temperature.

(4) The on-press drawing lithographic printing method as described in (2) above, wherein the oil ink is obtained by dispersing resin particles in a nonaqueous solvent having an electric resistivity of 10⁹ Ωcm or more and a dielectric constant of 3.5 or less and the resin particles are solid and hydrophobic at least at an ordinary temperature.

(5) The plate-making method as described in (1) above, wherein the prevention of coagulation and/or precipitation at least in the circulation of ink is performed before the ejection of ink.

(6) The on-press drawing lithographic printing method as described in (2) above, wherein the prevention of coagulation and/or precipitation at least in the circulation of ink is performed before the ejection of ink.

(7) The plate-making method as described in (1) above, wherein the prevention of coagulation and/or precipitation is to prevent the production of a bulked aggregate and/or a bulked precipitate of the oil ink at least in the circulation of ink.

(8) The on-press drawing lithographic printing method as described in (2) above, wherein the prevention of coagulation and/or precipitation is to prevent the production of a bulked aggregate and/or a bulked precipitate of the oil ink at least in the circulation of ink.

(9) The plate-making method as described in (1) above, wherein the prevention of coagulation and/or precipitation is performed at least in the circulation of ink by an operation containing at least one of stirring, dispersion, mixing and jetting.

(10) The on-press drawing lithographic printing method as described in (2) above, wherein the prevention of coagulation and/or precipitation is performed at least in the circulation of ink by an operation containing at least one of stirring, dispersion, mixing and jetting.

(11) The plate-making method as described in (9) above, wherein the stirring, dispersion, mixing and jetting operations are applied at least in the circulation of ink as a single operation, a plurality of operations or multiple operations.

(12) The on-press drawing lithographic printing method as described in (10) above, wherein the stirring, dispersion, mixing and jetting operations are applied at least in the circulation of ink as a single operation, a plurality of operations or multiple operations.

(13) The plate-making method as described in (9) above, wherein the stirring, dispersion, mixing or jetting operation is applied occasionally, periodically or continuously.

(14) The on-press drawing lithographic printing method as described in (10) above, wherein the stirring, dispersion, mixing or jetting operation is applied occasionally, periodically or continuously.

(15) The plate-making method as described in (1) above, wherein the coagulation and/or precipitation-preventing means is a cartridge type and exchangeable.

(16) The on-press drawing lithographic printing method as described in (2) above, wherein the coagulation and/or precipitation-preventing means is a cartridge type and exchangeable.

(17) A plate-making apparatus comprising image-forming means of forming an image directly on a plate material by an ink jet drawing device of ejecting an oil ink from an ejection head using an electrostatic field based on signals of image data, and image-fixing means of fixing the image formed by the image-forming means to obtain a printing plate, wherein at least one coagulation and/or precipitation-preventing means is provided on the flow path of the oil ink at least in the circulation of ink.

(18) An on-press drawing lithographic printing apparatus comprising image-forming means of forming an image directly on a plate material attached to a plate cylinder of a press based on signals of image data, and lithographic printing means of performing lithographic printing using a printing plate having thereon an image formed by the image-forming means, the image-forming means being an ink jet drawing device having a recording head of ejecting an oil ink using an electrostatic field, wherein at least one coagulation and/or precipitation-preventing means is provided on the flow path of the oil ink at least in the circulation of ink.

(19) The plate-making apparatus as described in (17) above, wherein the coagulation and/or precipitation-preventing means of preventing coagulation and/or precipitation in the circulation of ink is provided at least immediately before the ink ejection part of the ejection head.

(20) The on-press drawing lithographic printing apparatus as described in (18) above, wherein the coagulation and/or precipitation-preventing means of preventing coagulation and/or precipitation in the circulation of ink is provided at least immediately before the ink ejection part of the ejection head.

(21) The plate-making apparatus as described in (17) above, wherein the coagulation and/or precipitation-preventing means has a capacity of preventing the production of a bulked aggregate and/or a bulked precipitate of the oil ink at least in the circulation of ink.

(22) The on-press drawing lithographic printing apparatus as described in (18) above, wherein the coagulation and/or precipitation-preventing means has a capacity of preventing the production of a bulked aggregate and/or a bulked precipitate of the oil ink at least in the circulation of ink.

(23) The plate-making apparatus as described in (17) above, wherein the coagulation and/or precipitation-preventing means performs the prevention of coagulation and/or precipitation at least in the circulation of ink by an operation containing at least one of stirring, dispersion, mixing and jetting.

(24) The on-press drawing lithographic printing apparatus as described in (18) above, wherein the coagulation and/or precipitation-preventing means performs the prevention of coagulation and/or precipitation at least in the circulation of ink by an operation containing at least one of stirring, dispersion, mixing and jetting.

(25) The plate-making apparatus as described in (17) above, wherein the stirring, dispersion, mixing or jetting operation is applied at least in the circulation of ink as a single operation, a plurality of operations or multiple operations.

(26) The on-press drawing lithographic printing apparatus as described in (18) above, wherein the stirring, dispersion, mixing or jetting operation is applied at least in the circulation of ink as a single operation, a plurality of operations or multiple operations.

(27) The plate-making apparatus as described in (17) above, wherein the stirring, dispersion, mixing or jetting operation is applied occasionally, periodically or continuously.

(28) The on-press drawing lithographic printing apparatus as described in (18) above, wherein the stirring, dispersion, mixing or jetting operation is applied occasionally, periodically or continuously.

(29) The plate-making apparatus as described in (17) above, wherein the coagulation and/or precipitation-preventing means is composed of a cartridge type.

(30) The on-press drawing lithographic printing apparatus as described in (18) above, wherein the coagulation and/or precipitation-preventing means is composed of a cartridge type.

(31) The plate-making apparatus as described in (17) above, wherein the oil ink is obtained by dispersing resin particles in a nonaqueous solvent having an electric resistivity of 10⁹ Ωcm or more and a dielectric constant of 3.5 or less and the resin particles are solid and hydrophobic at least at an ordinary temperature.

(32) The on-press drawing lithographic printing apparatus as described in (18) above, wherein the oil ink is obtained by dispersing resin particles in a nonaqueous solvent having an electric resistivity of 10⁹ Ωcm or more and a dielectric constant of 3.5 or less and the resin particles are solid and hydrophobic at least at an ordinary temperature.

(33) The plate-making apparatus as described in (17) above, wherein the image-fixing means has heating means using a heat roller and/or an infrared lamp, a halogen lamp or a xenon flash lamp.

(34) The on-press drawing lithographic printing apparatus as described in (18) above, wherein the image-forming means has a fixing device for fixing the ink.

(35) The plate-making apparatus as described in (33) above, wherein the heating means is disposed and/or controlled to gradually elevate the temperature of the plate material at the time of fixing the image.

(36) The on-press drawing lithographic printing apparatus as described in (18) above, wherein the image-forming means has plate material surface dust-removing means of removing dusts present on the surface of a plate material before and/or during the drawing on the plate material.

(37) The plate-making apparatus as described in (17) above, wherein at the drawing on the plate material, the main scanning is performed by rotating a drum having attached thereto the plate material.

(38) The on-press drawing lithographic printing apparatus as described in (18) above, wherein at the drawing on the plate material, the image-forming means performs the main scanning by the rotation of a plate cylinder having attached thereto the plate material.

(39) The plate-making apparatus as described in (37) above, wherein the ejection head comprises a single channel head or a multi-channel head and the sub-scanning is performed by moving the ejection head in the direction parallel to the axis of the drum.

(40) The on-press drawing lithographic printing apparatus as described in (38) above, wherein the recording head comprises a single channel head or a multi-channel head and at the drawing on the plate material, the sub-scanning is performed by moving the recording head in the direction parallel to the axis of the plate cylinder.

(41) The plate-making apparatus as described in (17) above, wherein at the drawing on the plate material, the sub-scanning is performed by running the plate material while interposing and holding it between at least a pair of capstan rollers.

(42) The plate-making apparatus as described in (41) above, wherein the ejection head comprises a single channel head or a multi-channel head and the main scanning is performed by moving the ejection head in the direction orthogonal to the running direction of the plate material.

(43) The plate-making apparatus as described in (37) above, wherein the ejection head comprises a full line head having almost the same length as the width of the plate material.

(44) The on-press drawing lithographic printing apparatus as described in (38) above, wherein the recording head comprises a full line head having almost the same length as the width of the plate cylinder.

(45) The plate-making apparatus as described in (17) above, wherein the ink jet drawing device has ink feed means of feeding the oil ink to the ejection head.

(46) The on-press drawing lithographic printing apparatus as described in (18) above, wherein the ink jet drawing device has ink feed means of feeding ink to the recording head.

(47) The plate-making apparatus as described in (45) above, which comprises ink recovery means of recovering the oil ink from the ejection head and circulates the ink.

(48) The on-press drawing lithographic printing apparatus as described in (46) above, which comprises ink recovery means of recovering the ink from the recording head and circulates the ink by the ink feed means and the ink recovery means.

(49) The plate-making apparatus as described in (17) above, which comprises dust-removing means of removing S dusts present on the surface of the plate material before and/or during the drawing on the plate material.

(50) The on-press drawing lithographic printing apparatus as described in (18) above, which comprises ink-stirring means in an ink tank for storing the oil ink.

(51) The plate-making apparatus as described in (17) above, wherein the ink jet drawing device has ink temperature-controlling means of controlling the temperature of the oil ink, in an ink tank for storing the oil ink.

(52) The on-press drawing lithographic printing apparatus as described in (18) above, which comprises ink temperature-controlling means of controlling the temperature of ink, in an ink tank for storing the oil ink.

(53) The plate-making apparatus as described in (17) above, wherein the ink jet drawing device has ink concentration-controlling means of controlling the concentration of the oil ink.

(54) The on-press drawing lithographic printing apparatus as described in (6) above, which comprises ink concentration-controlling means of controlling the concentration of the ink.

(55) The on-press drawing lithographic printing apparatus as described in (18) above, wherein the ink jet drawing device has recording head-retreating or approximating means of approximating the recording head to the plate cylinder at the drawing on the plate material and retreating the recording head from the plate cylinder except for the drawing on the plate material.

(56) The plate-making apparatus as described in (17) above, which comprises cleaning means of cleaning the ejection head.

(57) The on-press drawing lithographic printing apparatus as described in (18) above, wherein the image-forming means has recording head-cleaning means of cleaning the recording head at least at the completion of plate-making.

(58) The on-press drawing lithographic printing apparatus as described in (18) above, wherein the lithographic printing means has paper dust-removing means of removing paper dusts generated at the lithographic printing.

### BRIEF DESCRIPTION OF THE DRAWINGS

FIG. 1 is an entire construction view schematically showing one example of the plate-making apparatus for use in the present invention.

FIG. 2 is an entire construction view schematically showing another example of the plate-making apparatus for use in the present invention.

FIG. 3 is a construction view schematically showing one example of the drawing part of the plate-making apparatus for use in the present invention.

FIG. 4 is a construction view of an apparatus imparted with an ink-circulating function.

FIG. 5 is a schematic construction view showing one example of the ejection head provided in the ink jet drawing device for use in the present invention.

FIG. 6 is a schematic cross-sectional view showing the vicinity of the ink ejection part of FIG. 5.

FIG. 7 is a schematic cross-sectional view showing the vicinity of the ink ejection part in another example of the ejection head provided in the ink jet drawing device for use in the present invention.

FIG. 8 is a schematic front view showing the vicinity of the ink ejection part of FIG. 7.

FIG. 9 is a schematic construction view showing main parts in another example of the ejection head provided in the ink jet drawing device for use in the present invention.

FIG. 10 is a schematic construction view of the ejection head of FIG. 9 from which regulating plates are removed.

FIG. 11 is a schematic construction view showing main parts in another example of the ejection head provided in the ink jet drawing device for use in the present invention.

FIG. 12 is a construction view showing the apparatus of FIG. 4 where a part of the apparatus is changed.

FIG. 13 is a schematic cross-sectional view showing coagulation and/or precipitation-preventing means.

FIG. 14 is a schematic cross-sectional view showing another coagulation and/or precipitation-preventing means.

FIG. 15 is a schematic cross-sectional view showing another coagulation and/or precipitation-preventing means.

FIG. 16 is a schematic cross-sectional view showing another coagulation and/or precipitation-preventing means.

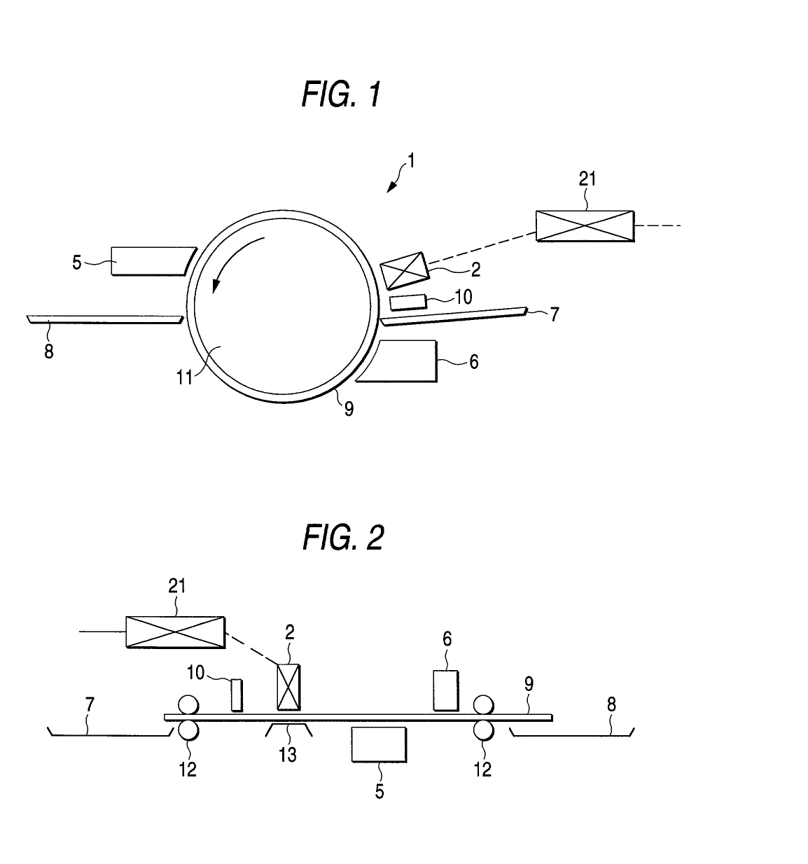

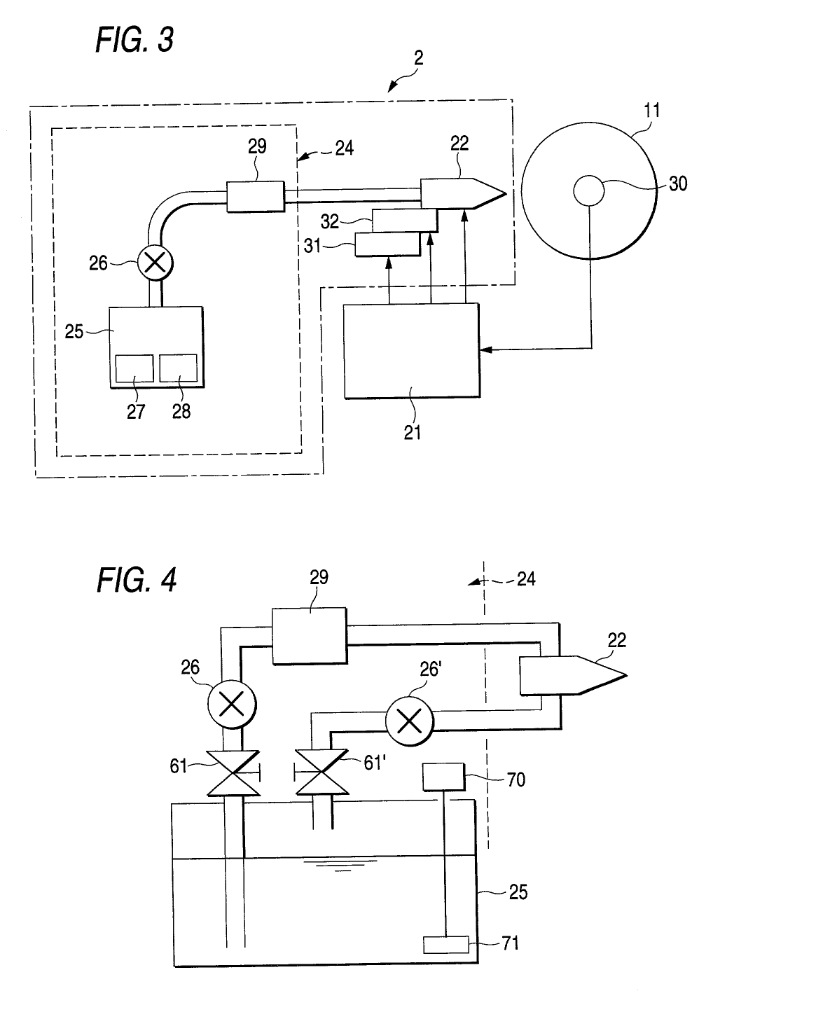

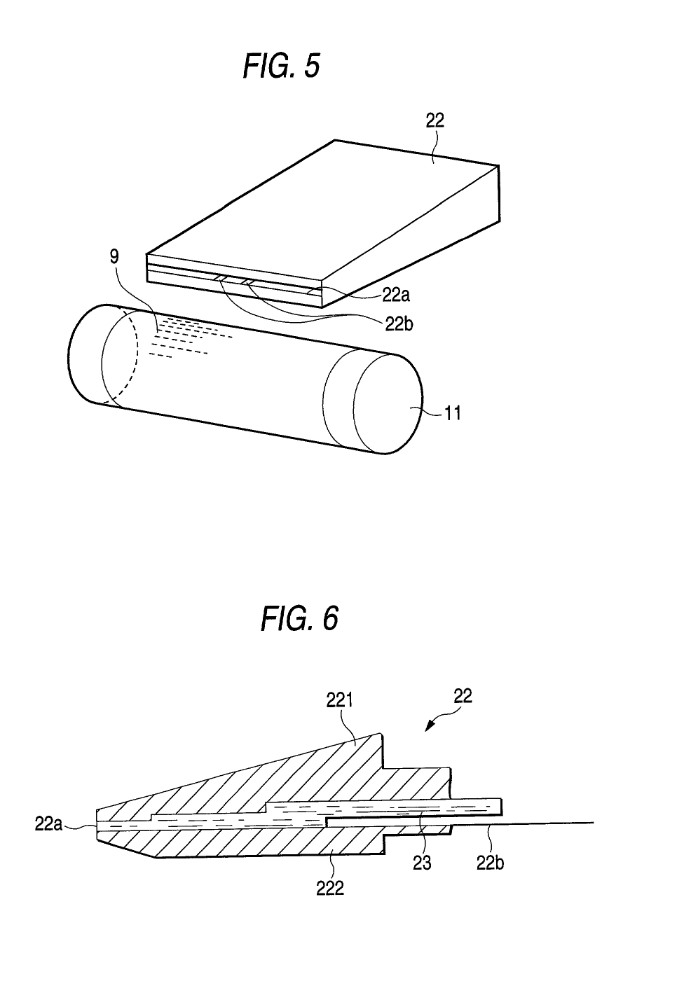

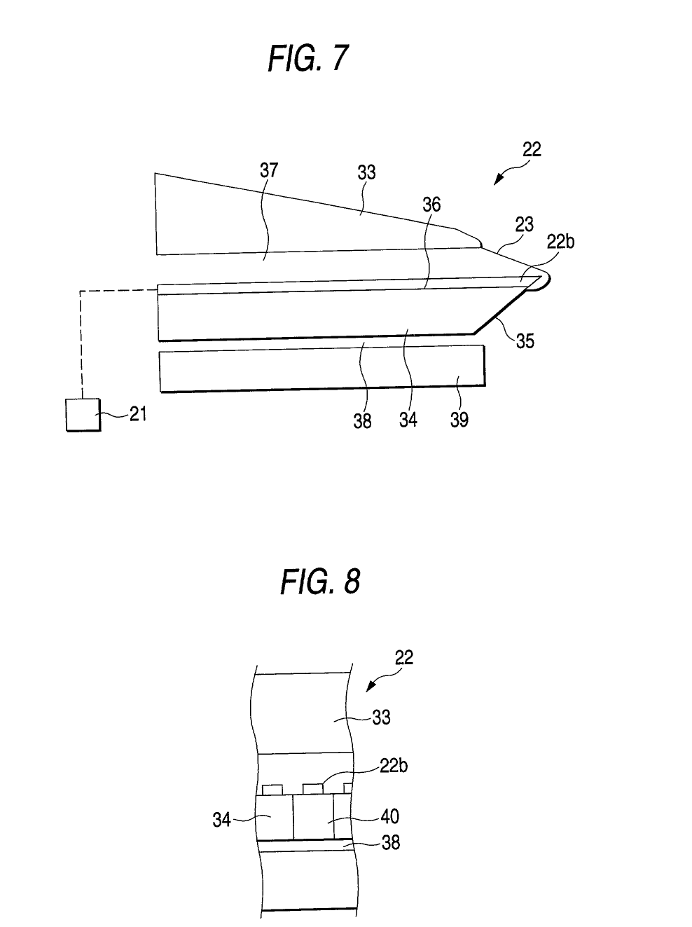

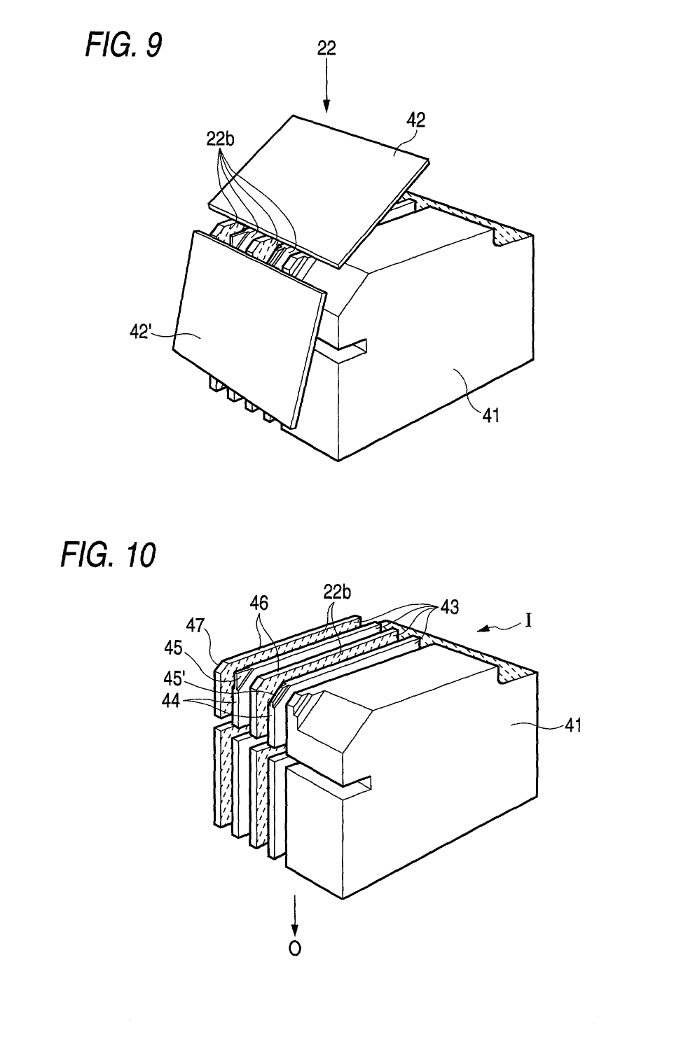

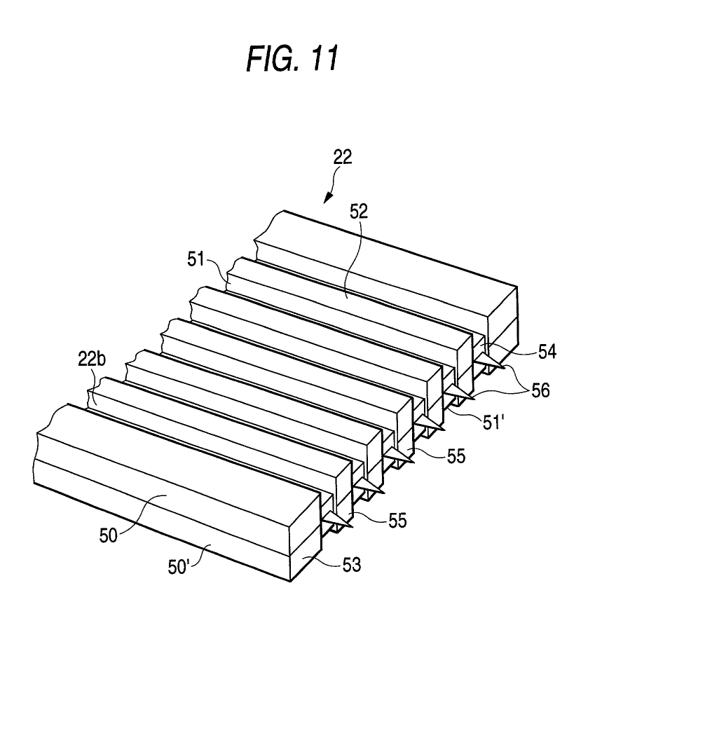

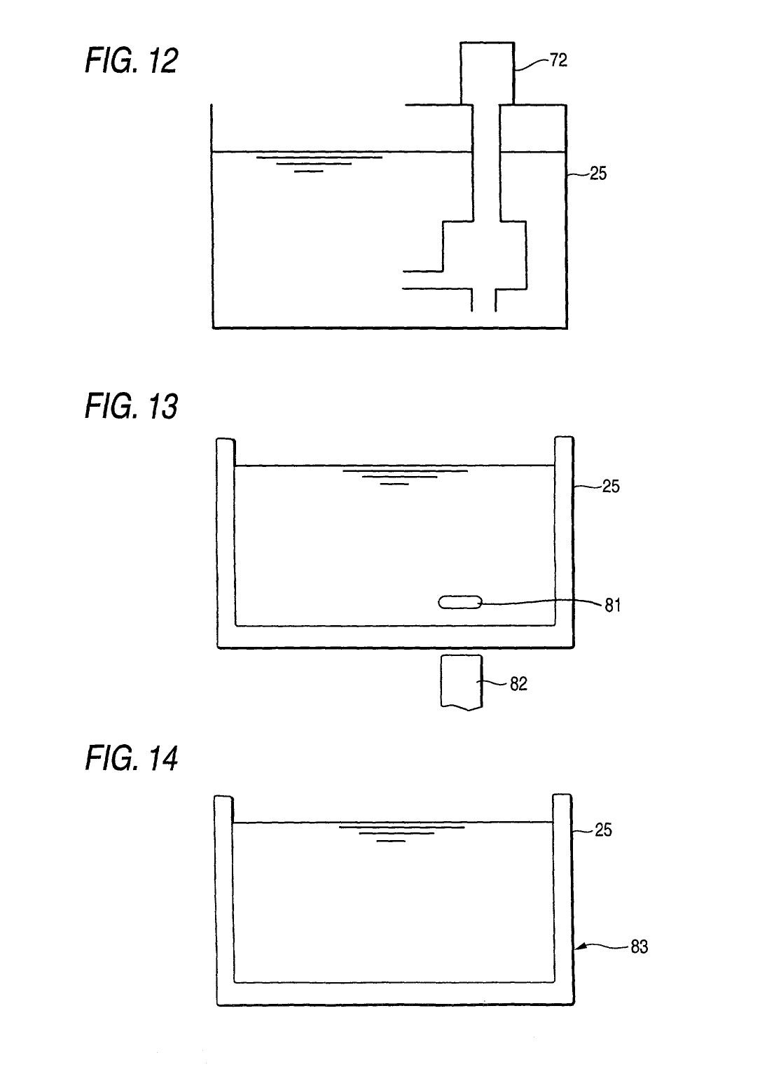

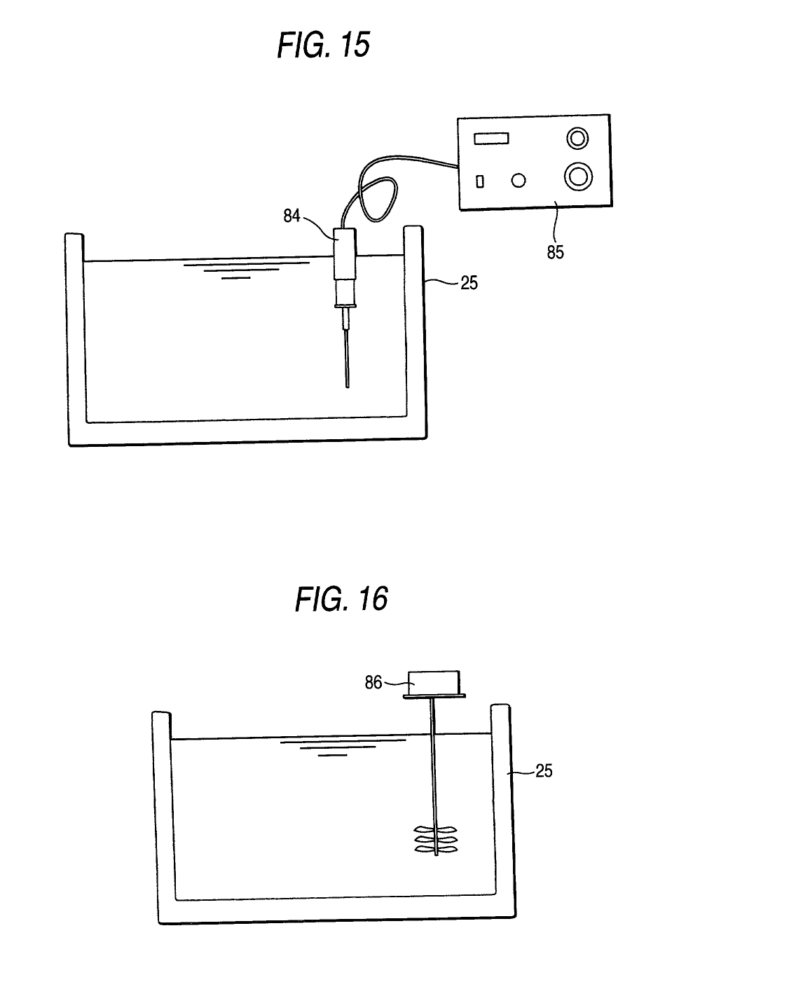

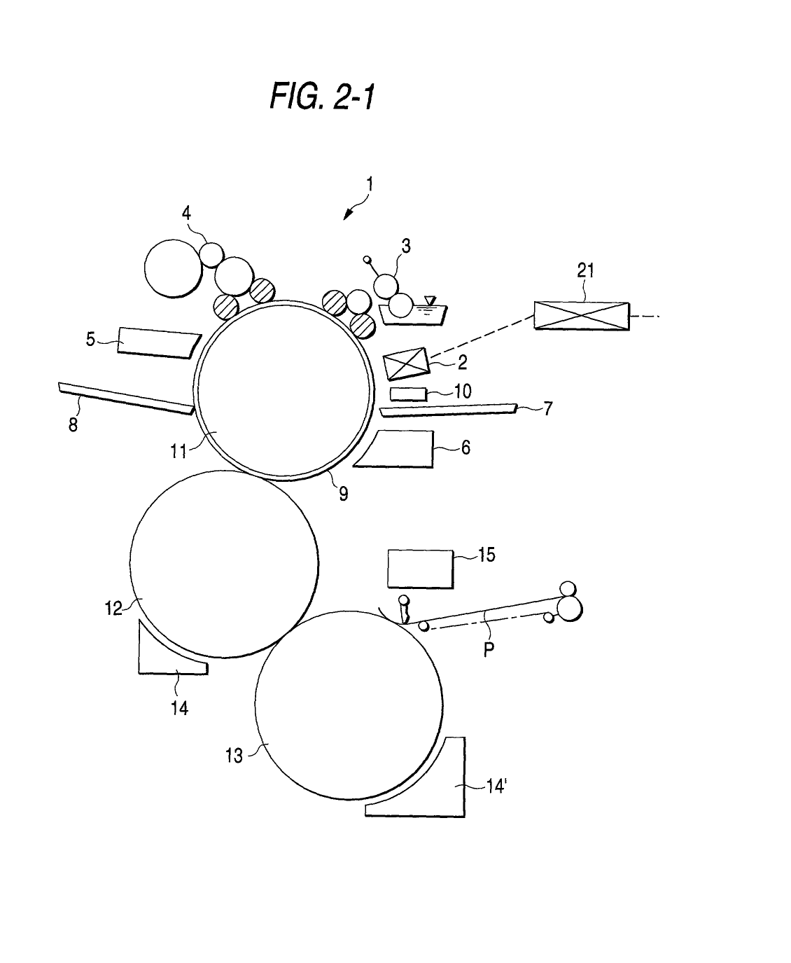

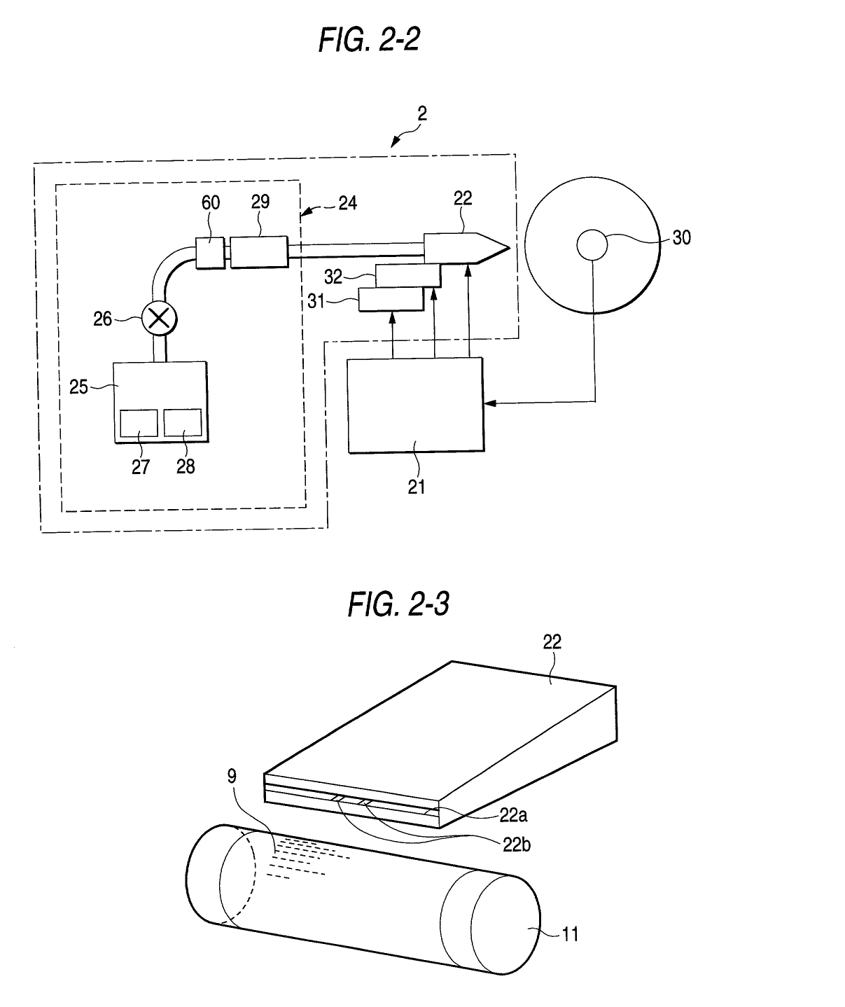

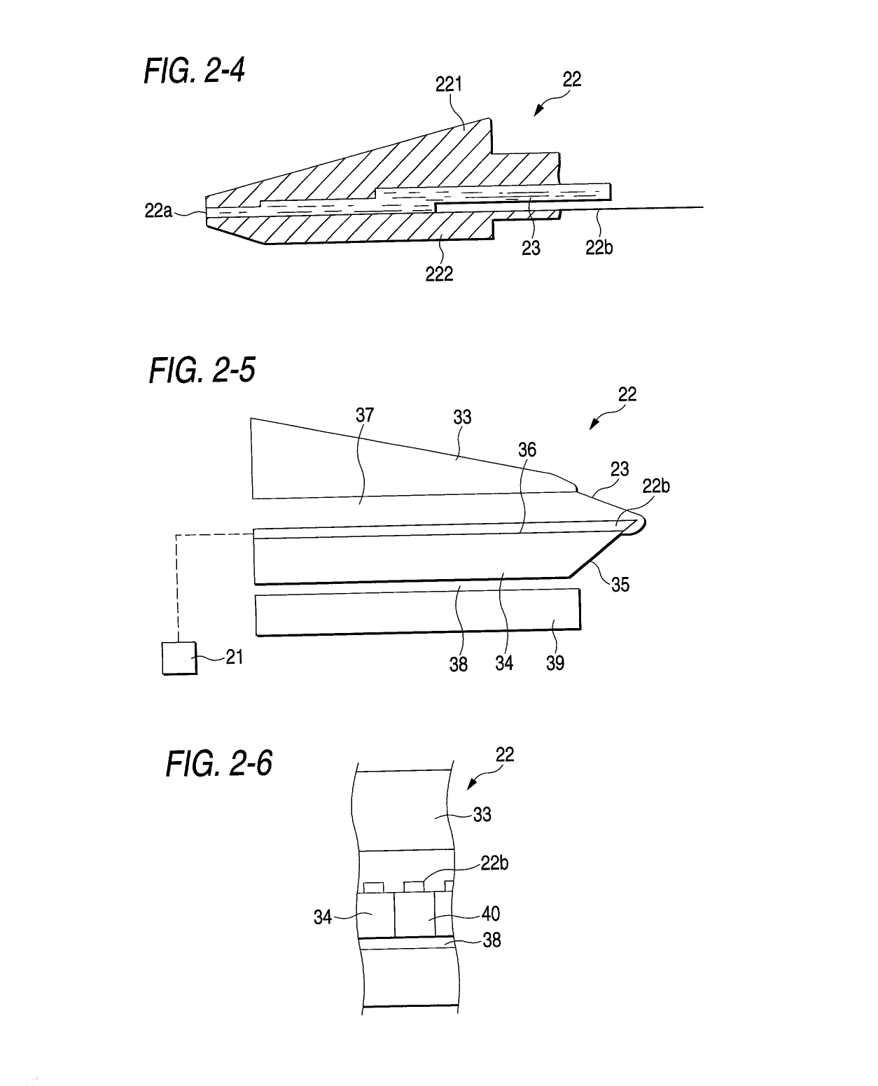

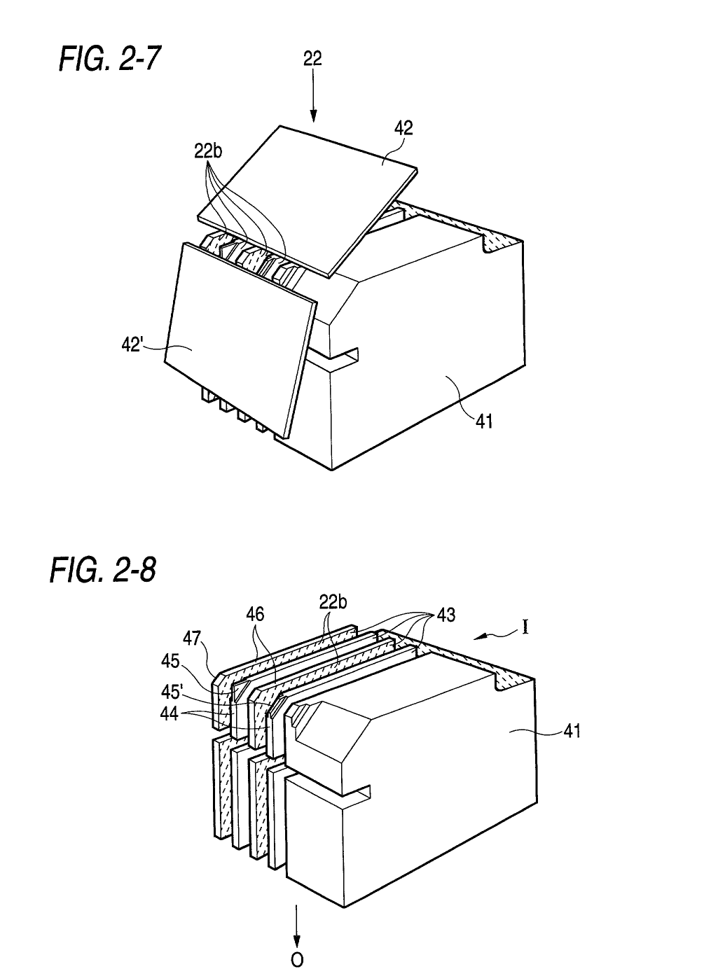

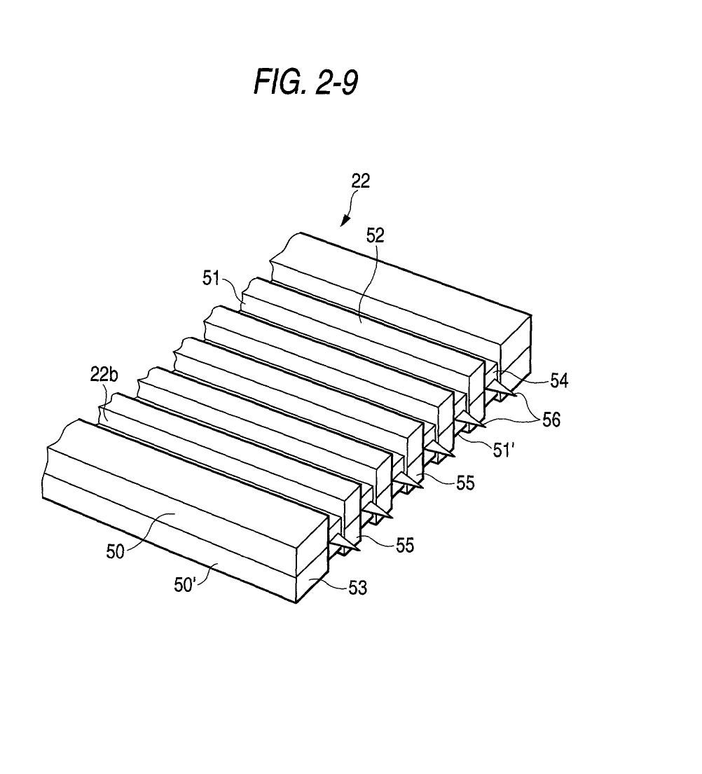

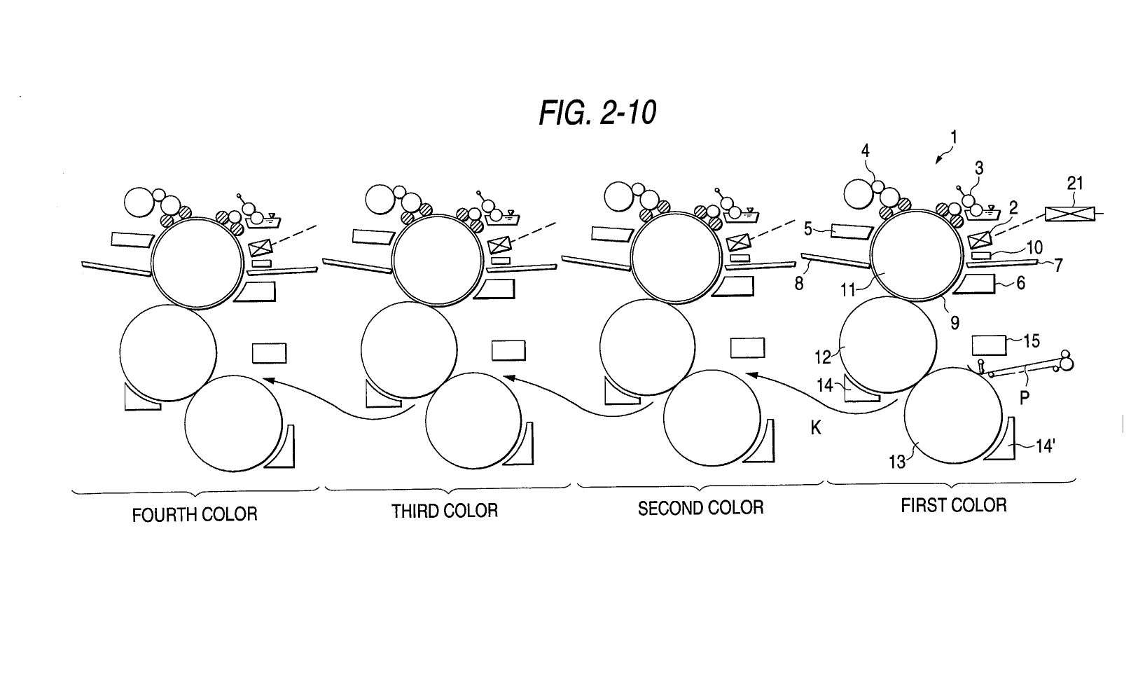

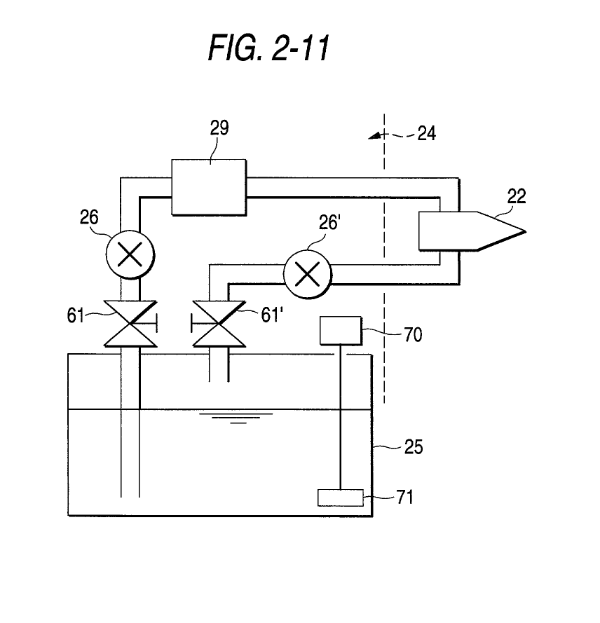

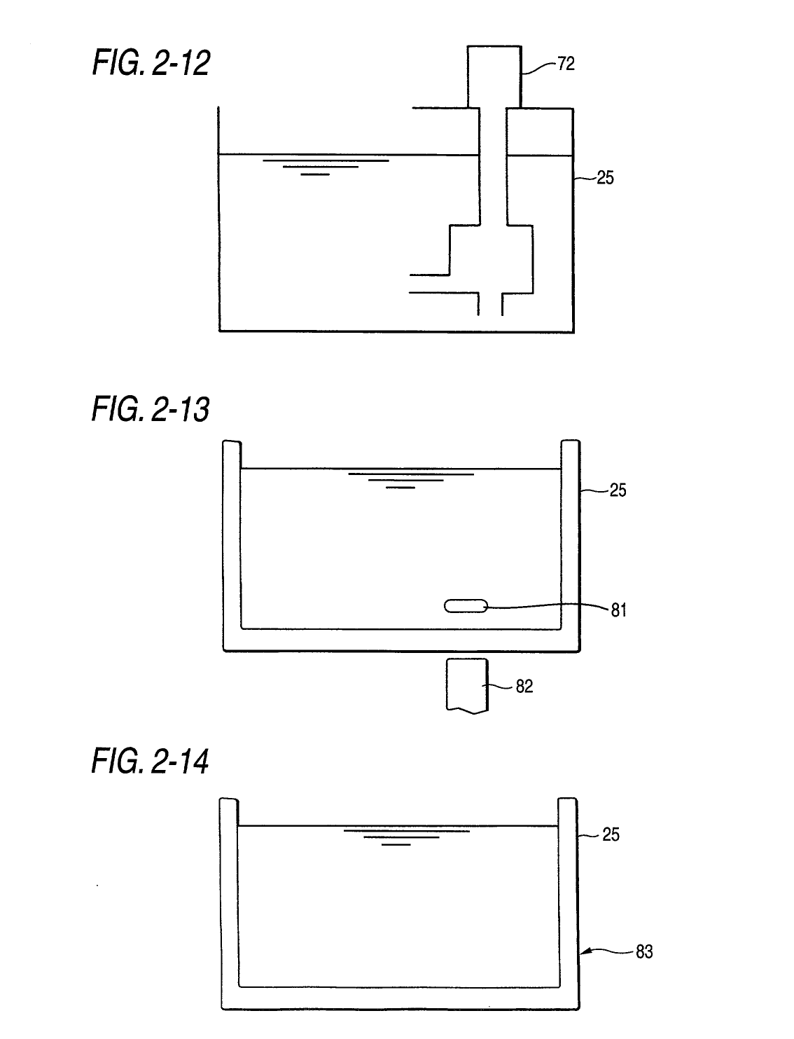

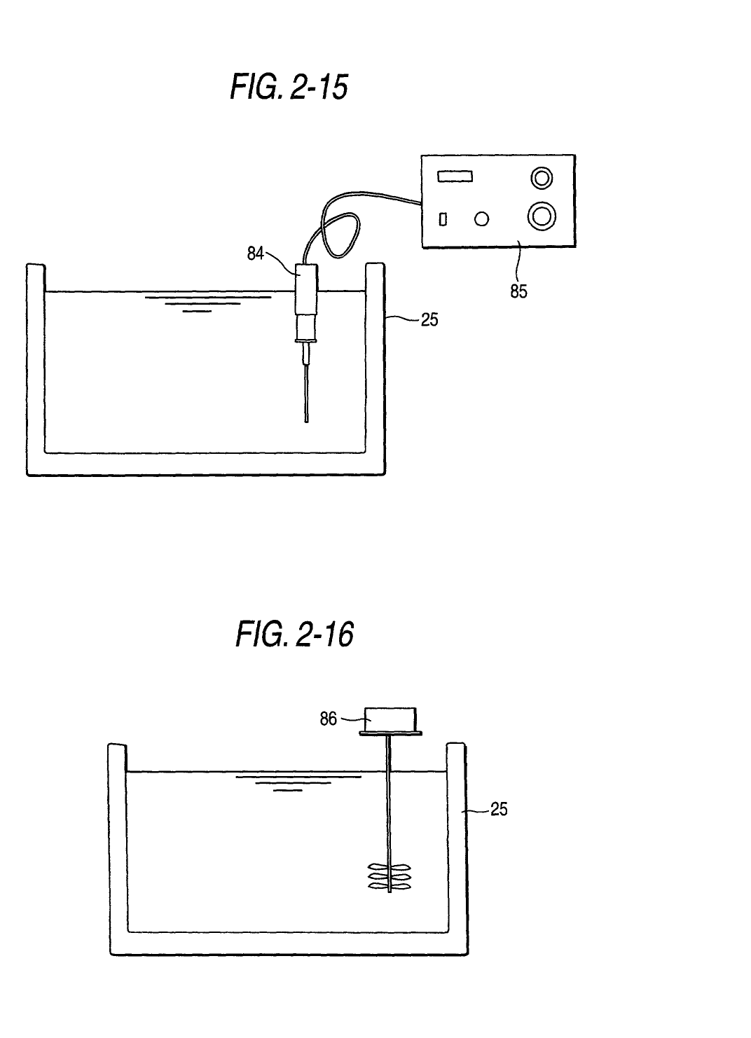

FIG. 2-1 is an entire construction view schematically showing one example of the on-press drawing lithographic printing apparatus for use in the present invention.

FIG. 2-2 is a construction view schematically showing one example of the on-press drawing lithographic printing apparatus for use in the present invention.

FIG. 2-3 is a schematic construction view showing one example of the head provided in the ink jet recording device for use in the present invention.

FIG. 2-4 is a schematic cross-sectional view showing the vicinity of the ink ejection part of FIG. 2-3.

FIG. 2-5 is a schematic cross-sectional view showing the vicinity of the ink ejection part in another example of the head provided in the ink jet recording device for use in the present invention.

FIG. 2-6 is a schematic front view showing the vicinity of the ink ejection part of FIG. 2-4.

FIG. 2-7 is a schematic construction view showing main parts in another example of the head provided in the ink jet recording device for use in the present invention.

FIG. 2-8 is a schematic construction view of the head of FIG. 2-7 from which regulating plates are removed.

FIG. 2-9 is a schematic construction view showing main parts in another example of the head provided in the ink jet recording device for use in the present invention.

FIG. 2-10 is an entire construction view schematically showing the on-press drawing four-color one-side lithographic printing machine as one example of the multiple color printing machine for use in the present invention.

FIG. 2-11 is a construction view showing the apparatus imparted with an ink-circulating function.

FIG. 2-12 is a construction view showing the apparatus of FIG. 2-11 where a part of the apparatus is changed.

FIG. 2-13 is a schematic cross-sectional view showing coagulation and/or precipitation-preventing means.

FIG. 2-14 is a schematic cross-sectional view showing another coagulation and/or precipitation-preventing means.

FIG. 2-15 is a schematic cross-sectional view showing another coagulation and/or precipitation-preventing means.

FIG. 2-16 is a schematic cross-sectional view showing another coagulation and/or precipitation-preventing means.

### DESCRIPTION OF REFERENCE CHARACTERS

1 plate-making apparatus

2 ink jet drawing device

5 fixing device

6 plate surface-desensitizing device

7 automatic plate feed device

8 automatic plate discharge device

9 plate material (printing plate precursor)

10 dust-removing means

11 drum

12 capstan roller

13 earthing means

21 image data arithmetic and control part

22 ejection head

221 upper unit

222 lower unit

22a ejection slit

22b ejection electrode

23 oil ink

24 ink feed part

25 ink tank

26 ink feed device

27 stirring means

28 ink temperature-controlling means

29 ink concentration-controlling means

30 encoder

31 head-retreating or approximating device

32 head sub-scanning means

33 first insulating substrate

34 second insulating substrate

35 inclined face part of second insulating substrate

36 upper face part of second insulating substrate

37 ink inflow path

38 ink recovery path

39 backing

40 groove

41 head body

42, 42′ meniscus regulating plates

43 ink groove

44 partition

45, 45′ ejection parts

46 partition

47 distal end of partition

50, 50′ support members

51, 51′ grooves

52 partition

53 upper end part

54 rectangular portion

55 upper end of partition

56 guide projection

61, 61′ valves

70 stirring motor

71 stirring blade

72 pump

81 magnetic spin bar

82 stirrer

83 ultrasonic bath

84 piezoelectric transducer

85 ultrasonic oscillator

86 vibrating blade

87 vibrator

2-1 on-press drawing lithographic printing apparatus

2-2 ink jet recording device

2-3 fountain solution feed device

2-4 printing ink feed device

2-5 fixing device

2-6 plate surface-desensitizing device

2-7 automatic plate feed device

2-8 automatic plate discharge device

2-9 plate material (printing plate precursor)

2-10 dust-removing means

2-11 plate cylinder

2-12 blanket cylinder

2-13 impression cylinder

2-14 blanket-cleaning device

2-14′ impression cylinder-cleaning device

2-15 paper dust generation-preventing device

2-21 image data arithmetic and control part

2-22 recording head

2-221 upper unit

2-222 lower unit

2-22a ejection slit

2-22b ejection electrode

2-23 oil ink

2-24 ink feed part

2-25 ink tank

2-26 ink feed device

2-27 stirring means

2-28 ink temperature-controlling means

2-29 ink concentration-controlling means

2-30 encoder

2-31 head-retreating or approximating device

2-32 head sub-scanning means

2-33 first insulating substrate

2-34 second insulating substrate

2-35 inclined face part of second insulating substrate

2-36 upper face part of second insulating substrate

2-37 ink inflow path

2-38 ink recovery path

2-39 backing

2-40 groove

2-41 head body

2-42, 2-42′ meniscus regulating plates

2-43 ink groove

2-44 partition

2-45, 2-45′ ejection parts

2-46 partition

2-47 distal end of partition

2-50, 2-50′ support members

2-51, 2-51′ grooves

2-52 partition

2-53 upper end part

2-54 rectangular portion

2-55 upper end of partition

2-56 guide projection

2-61, 2-61′ valves

2-70 stirring motor

2-71 stirring blade

2-72 pump

2-81 magnetic spin bar

2-82 stirrer

2-83 ultrasonic bath

2-84 piezoelectric transducer

2-85 ultrasonic oscillator

2-86 vibrating blade

2-87 vibrator

### DETAILED DESCRIPTION OF THE INVENTION

The first embodiment of the present invention is described in detail below.

The present invention is characterized in that an image is formed on a plate material (printing plate precursor) by an ink jet process of ejecting an oil ink using electrostatic field.

In the present invention, the size of the ink droplet ejected is determined by the size of the tip of the ejection electrode or the conditions in forming the electric field. Therefore, a small ink droplet can be obtained by using a small ejection electrode or controlling the conditions in forming an electric field, without reducing the ejection nozzle size or the ejection slit width. Accordingly, the present invention provides a plate-making method and a plate-making apparatus, where a fine image can be controlled without causing any problem of ink clogging in the head and a printing plate capable of printing a large number of printed matters having a clear image can be obtained.

Construction examples of the plate-making apparatus for use in practicing the plate-making method of the present invention are described below.

FIGS. 1 and 2 each is an entire construction view of a plate-making apparatus. FIG. 3 is a view schematically showing a construction example of the plate-making apparatus including the control part, the ink feed part and the head-retreating or approximating mechanism. FIGS. 4 to 10 each is a view for explaining the ink jet drawing device of the plate-making apparatus of FIGS. 1 and 2.

The process of practicing the plate-making according to the present invention is described below using an entire construction view of a plate-making apparatus having a structure shown in FIG. 1 where a plate material is attached to a drum 11, however, the present invention is not limited to the following construction example.

The drum 11 is usually made of a metal such as aluminum, stainless steel and iron, a plastic, a glass or the like. Particularly, in the case of a metal-made drum, the surface thereof is subjected to, for example, an alumite treatment or a chromium plating in many cases so as to strengthen the abrasion resistance or corrosion resistance. The drum 11 may have a heat insulating material on the surface thereof as described later. The drum 11 acts as a counter electrode of the ejection head electrode at the electrostatic field ejection and preferably has an earth function. In the case where the substrate of the plate material has high insulating property, an electrically conducting layer is preferably provided on the substrate and in this case, means for taking the earth is preferably provided in this electrically conducting layer. Also in the case of providing a heat insulating material on the drum 11, the drawing may be facilitated by providing means for taking the earth on the plate material and for this purpose, known means having electrical conductivity, such as brush, leaf spring or roller, may be used.

The plate-making apparatus 1 further has an ink jet drawing device 2 which ejects an oil ink on the plate material 9 attached to the drum 11 in correspondence to the image data sent from an image data arithmetic and control part 21 and thereby forms an image.

The plate-making apparatus 1 further has a fixing device 5 for strengthening the oil ink image drawn on the plate material 9. If desired, a plate surface desensitizing device 6 may be provided for the purpose of intensifying the hydrophilicity on the surface of the plate material 9. The plate-making apparatus 1 further has dust-removing means 10 of removing dusts present on the surface of the plate material 9 before and/or during the drawing on the plate material 9. By this means, the ink can be effectively prevented from adhering to the plate material 9 by the help of dusts invaded between the head and the plate material during the plate-making and thereby, good plate-making can be performed. For the dust-removing means 10, a known non-contact method such as suction removal, blowing removal or electrostatic removal, or a contact method by a brush, a roller or the like may be used. In the present invention, air suction, air blowing or a combination thereof is preferably used.

Furthermore, an automatic plate feed device 7 of automatically feeding the plate material 9 to the drum 11 and an automatic plate discharge device 8 of automatically removing the plate material 9 from the drum 11 after the completion of drawing may be provided. By using these automatic plate feed device 7 and automatic plate discharge device 8, the plate-making operation is more facilitated and the plate-making time can be shortened, as a result, the effect of the present invention is more enhanced.

The process of preparing a printing plate using the plate-making apparatus 1 is described below by referring to FIG. 1 and partially to FIG. 3.

A plate material 9 is attached to the drum 11 using an automatic plate feed device 7. At this time, the plate material 9 is tightly fixed on the drum 11 by a mechanical method using a known plate head/edge gripping device, an air suction device or the like, or by an electrostatic method, so that the edge of plate can be prevented from fluttering to come into contact with the ink jet drawing device 2 during the drawing and cause damages. Furthermore, means of tightly contacting the plate material 9 to the drum 11 only in the periphery of the drawing position of the ink jet drawing device 2 may be provided and by actuating this at least at the time of performing the drawing, the plate material 9 can be prevented from contacting with the ink jet drawing device 2. To speak specifically, for example, a method of disposing a presser roller upstream and downstream the drawing position on the drum 11 may be used. At the time of not performing the drawing, the head is preferably kept apart from the plate material, whereby the ink jet drawing device 2 can be effectively prevented from generation of troubles such as damage by contact.

The image data arithmetic and control part 21 receives image data from an image scanner, a magnetic disc device, an image data transmission device or the like, performs color separation, if desired, and then partitions and computes the separated data into an appropriate number of picture elements or an appropriate number of gradations. Furthermore, since the oil ink image is drawn as a dotted image using an ink jet ejection head 22 (which is described in detail later; see, FIG. 3) of the ink jet drawing device 2, the halftone dot area factor is also computed. In addition, as described later, the image data arithmetic and control part 21 controls the movement of the ink jet ejection head 22, the timing of ejecting the oil ink and if desired, the timing of operating the drum 11 and the like. These data computed and input in the image data arithmetic and control part 21 are once stored in a buffer. The image data arithmetic and control part 21 rotates the drum 11 and approximates the ejection head 22 to the position proximate to the drum 11 using a head-retreating or approximating device 31. The ejection head 22 and the surface of the plate material 9 on the drum 11 are kept at a predetermined distance during the drawing under mechanical distance control using a knock roller or the like, or under control of the head-retreating or approximating device based on the signals from an optical distance detector. By virtue of this distance control, good plate-making can be performed without causing non-uniformity in the dot size due to floating of the plate material or particularly without causing any change in the dot size even when vibration is applied to the plate-making machine.

For the ejection head 22, a single channel head, a multi-channel head or a full line head may be used. The main scanning is performed by the rotation of the drum 11. In the case of a multi-channel head having a plurality of ejection parts or a full line head, the direction in which the ejection parts are arrayed is set to the axial direction of the drum 11. Furthermore, in the case of a single channel head or a multi-channel head, the image data arithmetic and control part 21 moves the ejection head 22 in the direction parallel to the axis of the drum 11 every each rotation of the drum 11 and an oil ink is ejected to the plate material 9 attached to the drum 11 based on the ejection position and the halftone dot area factor obtained by the computation. Upon this ejection, a halftone image is drawn on the plate material 9 by the oil ink according to the variable density of the printing original. This operation continues until an oil ink image of one color portion of the printing original is formed on the plate material 9 and thereby, a printing plate is finished. On the other hand, in the case where the ejection head 22 is a full line head having almost the same length as the width of the drum 11, an oil ink image of one color portion of the printing original is formed on the plate material 9 by one rotation of the drum 11 and thereby a printing plate is finished. Since the main scanning is performed as such by the rotation of the drum 11, the positional precision in the main scanning direction can be elevated and high-speed drawing can be performed.

Subsequently, the ejection head 22 is retreated to come apart from the position proximate to the drum 11 so as to protect the ejection head 22. This retreating or approximating means is operated to separate the ejection head at least 500 μm or more apart from the drum except for the drawing time. The retreating/approximating operation may be performed by a slide system or in a pendulum manner by fixing the ejection head 22 using an arm fixed to a certain axis and moving the arm around the axis. By retreating the ejection head 22 at the non-drawing time, the ejection head 22 can be protected from physical breakage or contamination and can have a long life.

The formed oil ink image is strengthened by a fixing device 5. For this ink fixing means, known means such as heat fixing or solvent fixing may be used. In the heat fixing, hot air fixing by the irradiation of an infrared lamp, a halogen lamp or a xenon flash lamp or using a heater, or heat roll fixing is generally employed. In this case, the fixing property can be effectively elevated by using means of heating the drum, means of preheating the plate material 9, means of performing the drawing while applying hot air, means of coating the drum 11 with a heat insulating material or means of keeping the plate material 9 apart from the drum 11 and heating only the plate material 9 at the fixing, and these means may be used individually or in combination. The flash fixing using a xenon lamp or the like is known as a fixing method of electrophotographic toner and this is advantageous in that the fixing can be performed within a short time. In the case of using a paper plate material, the water content inside the plate material abruptly evaporates due to the abrupt elevation of the temperature and a phenomenon called blister of generating asperities on the surface of the plate material takes place. Therefore, it is preferred to gradually elevate the temperature of the paper plate material by gradually increasing the power supply to the heat source while rotating the drum 11 or by changing the rotational speed from high to low with a constant power supply. The temperature of the paper plate material may also be gradually elevated by disposing a plurality of fixing tools in the rotational direction of the drum 11 and varying the distance from these to the plate material 9 and/or the supply capability.

In the solvent fixing, a solvent capable of dissolving the resin components in the ink, such as methanol and ethyl acetate, is sprayed or the plate material is exposed to the solvent vapor while recovering excess solvent vapor.

At least in the process from the formation of an oil ink image by the ejection head 22 until the fixing by the fixing device 5, the image on the plate material 9 is preferably kept not to come into contact with any thing.

A construction example of the plate-making apparatus which performs the sub-scanning by running a plate material 9 is described below using FIG. 2, however, the present invention is not limited to the following construction example.

A plate material 9 is transported while being interposed and held between two pairs of captain rollers 12 and using data partitioned and computed into an appropriate number of picture elements and an appropriate number of gradations by an image data arithmetic and control part 21, an image is drawn by an ink jet drawing device 2. In the position where an image is drawn by the ink jet drawing device 2, earth means 13 is preferably provided to work out to a counter electrode of the ejection head electrode at the time of electrostatic field ejection, whereby the drawing is facilitated. In the case where the substrate of the plate material 9 has high insulating property, an electrically conducting layer is preferably provided on the substrate and in this case, this electrically conducting layer is preferably earthed by known means having electrical conductivity, such as brush, leaf spring or roller.

FIG. 2 shows an apparatus where a sheet plate material is used. However, a roll plate material is also suitably used and in this case, a sheet cutter is preferably provided upstream the automatic plate discharge device. The plate-making apparatus further has an ink jet drawing device 2 which ejects an oil ink on the plate material 9 in correspondence to the image date sent from the image data arithmetic and control part 21 and forms an image.

The plate-making apparatus 1 further has a fixing device 5 for strengthening the oil ink image drawn on the plate material 9. If desired, a plate surface desensitizing device 6 may be provided for the purpose of intensifying the hydrophilicity on the surface of the plate material 9. The plate-making apparatus 1 further has dust-removing means 10 of removing dusts present on the surface of the plate material before and/or during the drawing on the plate material 9. By this means, the ink can be effectively prevented from adhering to the plate material by the help of dusts invaded between the ejection head and the plate material during the plate-making and thereby, good plate-making can be attained. For the dust-removing means 10, a known non-contact method such as suction removal, blowing removal or electrostatic removal, or a contact method by a brush, a roller or the like may be used. In the present invention, air suction, air blowing or a combination thereof is preferably used.

Furthermore, an automatic plate feed device 7 of automatically feeding the plate material 9 and an automatic plate discharge device 8 of automatically removing the plate material 9 after the completion of drawing are preferably provided. By using these automatic plate feed device 7 and automatic plate discharge device 8, the plate-making operation is more facilitated and the plate-making time can be shortened, as a result, the effect of the present invention is more elevated.

The process of preparing a printing plate using the plate-making apparatus 1 is further described below by referring to FIG. 2 and partially to FIG. 3.

A plate material 9 is transported using an automatic plate feed device 7 and captain rollers 12. At this time, if desired, printing material guide means (not shown) or the like may be provided so as to prevent the head/edge of the plate material from fluttering and contacting with an ink jet drawing device 2 to cause damages. Furthermore, means of preventing loosening of the plate material 9 only in the periphery of the drawing position of the ink jet drawing device 2 may be provided and by actuating this means at least at the time of performing the drawing, the plate material 9 can be prevented from contacting with the ink jet drawing device 2. To speak specifically, for example, a method of disposing a presser roller upstream and downstream the drawing position may be used. At the time of not performing the drawing, the ejection head is preferably kept apart from the plate material 9, whereby the ink jet drawing device 2 can be effectively prevented from generation of troubles such as damage by contact.

The image data from a magnetic disk device or the like is given to an image data arithmetic and control part 21 and according to the input image data, the image data arithmetic and control part 21 computes the position of ejecting an oil ink and the halftone dot area factor at that position. These computed data are once stored in a buffer.

The image data arithmetic and control part 21 moves the ejection head 22, controls the timing of ejecting the oil ink and the timing of operating the capstan rollers, and if desired, approximates the ejection head 22 to the position proximate to the plate material 9 using a head-retreating or approximating device 31.

The ejection head 22 and the surface of the plate material 9 are kept at a predetermined distance during the drawing under mechanical distance control using a knock roller or the like, or under control of the head-retreating or approximating device based on the signals from an optical distance detector. By virtue of this distance control, good plate-making can be performed without causing non-uniformity in the dot size due to floating of the plate material or particularly without causing any change in the dot size even when vibration is applied to the plate-making machine.

For the ejection head 22, a single channel head, a multi-channel head or a full line head may be used and the sub-scanning is performed by the transportation of the plate material 9. In the case of a multi-channel head having a plurality of ejection parts, the direction in which ejection parts are arrayed is set almost in parallel to the running direction of the plate material. Furthermore, in the case of a single channel head or a multi-channel head, the ejection head 22 is moved in the direction orthogonal to the running direction of the plate material 9 by the image data arithmetic and control part 21 every each movement of the plate material and an oil ink is ejected to the plate material 9 based on the ejection position and halftone dot area factor obtained by the computation. Upon this ejection, a halftone image is drawn on the plate material 9 by the oil ink according to the variable density of the printing original. This operation continues until an oil ink image of one color portion of the printing original is formed on the plate material 9 and thereby, a printing plate is finished. On the other hand, in the case where the ejection head 22 is a full line head having almost the same length as the width of the plate material 9, the direction in which the ejection parts are arrayed is set almost orthogonal to the running direction of the plate material and an oil ink image of one color portion of the printing original is formed on the plate material 9 on passing of the plate material 9 through the drawing part, thereby finishing a printing plate.

The ejection head 22 is preferably retreated to come apart from the position proximate to the plate material 9 so as to protect the ejection head 22. This retreating or approximating means is operated to separate the ejection head at least 500 μm or more apart from the plate material 9 except for the drawing time. The retreating or approximating operation may be performed by a slide system or in a pendulum manner by fixing the ejection head using an arm fixed to a certain axis and moving the arm around the axis. By retreating the ejection head at the non-drawing time, the ejection head can be protected from physical breakage or contamination and can have a long life.

The formed oil ink image is strengthened by a fixing device 5. For the ink fixing means, known means such as heat fixing or solvent fixing may be used. In the heat fixing, hot air fixing by the irradiation of an infrared lamp, a halogen lamp or a xenon flash lamp or using a heater, or heat roll fixing is generally employed. The flash fixing using a xenon lamp or the like is known as a fixing method of electrophotographic toner and this is advantageous in that the fixing can be performed within a short time. In the case of using a paper plate material, the water content inside the plate material abruptly evaporates due to abrupt elevation of the temperature and a phenomenon called blister of generating asperities on the surface of the plate material takes place. Therefore, for preventing the blister of the plate material 9, it is preferred to dispose a plurality of fixing tools and gradually elevate the temperature of the paper plate material by changing the power supply and/or the distance from the fixing tools to the plate material 9.

In the solvent fixing, a solvent capable of dissolving the resin components in the ink, such as methanol and ethyl acetate, is sprayed or the plate material is exposed to the solvent vapor while recovering excess solvent vapor.

At least in the process from the formation of an oil ink image by the ejection head 22 until the fixing by the fixing device 5, the image on the plate material 9 is preferably kept not to come into contact with any thing.

The obtained printing plate is subjected to printing by a known lithographic printing method. More specifically, the printing plate having formed thereon the oil ink image is mounted on a press, a printing ink and a fountain solution are given thereto to form a printing ink image, the printing ink image is transferred to a blanket cylinder rotating together with the plate cylinder and subsequently, the printing ink image on the blanket cylinder is transferred to a printing paper sheet passing between the blanket cylinder and an impression cylinder, thereby performing the printing of one color portion. After the completion of printing, the printing plate is removed from the plate cylinder and the blanket on the blanket cylinder is cleaned by a blanket cleaning device to provide a state ready for next printing.

The ink jet drawing device 2 is described below.

As shown in FIG. 3, the ink jet drawing device 2 for use in the plate-making apparatus comprises an ink jet ejection head 22 and an ink feed part 24. The ink feed part 24 further comprises an ink tank 25, an ink feed device 26 and ink concentration-controlling means 29 and in the ink tank 25, stirring means 27 and ink temperature-controlling means 28 are contained. The ink may be circulated in the ejection head 22 and in this case, the ink feed part 24 additionally has a recovery and circulating function. The stirring means 27 is coagulation and/or precipitation-preventing means of preventing precipitation and coagulation of ink by a stirring operation or the like and prevents the precipitation/coagulation of solid contents in the ink to reduce the need for cleaning of the ink tank 25. For the stirring means 27 of preventing coagulation and/or precipitation, a rotary blade, a piezoelectric transducer and a circulation pump are used individually or in combination. This is described in detail later. The ink temperature-controlling means 28 is disposed such that the physical property of ink or the dot size does not vary due to change in the ambient temperature and a high-quality image can be stably formed. For the ink temperature-controlling means, a known method may be used, for example, a method of disposing a heat-generating element or a cooling element such as heater or Peltier device within the ink tank 25 together with the stirring means 27 and keeping constant the temperature distribution within the ink tank 25 under control by a temperature sensor such as thermostat. The ink temperature within the ink tank 25 is preferably from 15 to 60° C., more preferably from 20 to 50° C. The stirring means of keeping constant the temperature distribution within the ink tank 25 may be used in common as the stirring means of preventing the precipitation/coagulation of solid components in the ink.

The ink feed device 24 may be designed, as shown in FIG. 4, to circulate ink within the head. As shown in FIG. 4, the ink feed part additionally has a recovery and circulating function by a pump 26′ and a valve 61′. Furthermore, filtering means such as filter may be disposed immediately before the ejection head 22, whereby a clean ink free of paper fiber, dusts and the like can be fed to the ejection head 22.

The plate-making apparatus of the present invention preferably has ink concentration-controlling means 29 so as to draw a high-quality image. By having this means, generation of bleeding on the plate or slipping or thinning of the printing image due to reduction in the solid concentration in the ink, or change in the dot size on the plate due to increase in the solid concentration, can be effectively prevented. The ink concentration is controlled by measuring the physical properties using, for example, optical detection or measurement of electrical conductivity or viscosity or by counting the number of plates subjected to the drawing. In the case of controlling the ink concentration by measuring the physical properties, an optical detector, an electrical conductivity-measuring meter and a viscosity-measuring meter are provided individually or in combination within the ink tank 25 or on the flow path of ink and according to the output signals thereof, the feed of liquid to the ink tank 25 from a concentrated ink tank for replenishment (not shown) or from a diluting ink carrier tank is controlled. In the case of controlling the ink concentration by counting the number of plates subjected to the drawing, the feed of liquid is controlled by the number of plates manufactured and the frequency of plate-making.

The image data arithmetic and control part 21 computes the input image data and moves the ejection head 22 using a head-retreating or approximating device 31 or head sub-scanning means 32 as described above and additionally, takes in the timing pulse from an encoder 30 disposed in the drum 11 or a capstan roller and drives the ejection head 22 according to the timing pulse. By this, the positional precision is enhanced.

The ejection head 22 is described below using FIGS. 5 to 11, however, the present invention is not limited thereto.

FIGS. 5 and 6 each is a view showing one example of the ejection head provided in the ink jet drawing device. The ejection head 22 has a slit sandwiched by an upper unit 221 and a lower unit 222 each composed of an insulating base material and the distal end of the slit works out to an ejection slit 22a. Within the slit, an ejection electrode 22b is disposed and the slit is filled with an ink 23 fed from the ink feed device. Examples of the insulating base material which can be used include plastics, glass and ceramics. The ejection electrode 22b is formed by a known method, for example, a method of subjecting the lower unit 222 composed of an insulating base material to vapor deposition, sputtering or electroless plating with an electrically conductive material such as aluminum, nickel, chromium, gold or platinum, coating a photoresist thereon, exposing the photoresist through a predetermined electrode pattern mask, developing it to form a photoresist pattern of the ejection electrode 22b and etching the pattern, a method of mechanically removing the photoresist pattern or a method comprising a combination thereof.

As shown in FIG. 5, a drum 11 which works out to a counter electrode is provided to face the ejection electrode 22b provided in the ejection head 22 and on the drum 11 as the counter electrode, a plate material 9 is provided. When a voltage is applied to the ejection electrode 22b according to digital signals of the image pattern information, a circuit is formed between the ejection electrode 22b and the drum 11 as the counter electrode, and an oil ink 23 is ejected from the ejection slit 22a of the head 22 to form an image on the plate material 9 provided on the drum 11 as the counter electrode.

With respect to the width of the ejection electrode 22b, the tip thereof is preferably as narrow as possible for forming a high-quality image. The specific numerical value varies according to the conditions such as applied voltage and physical properties of ink, but the tip width is usually from 5 to 100 μm.

For example, a dot of 40 μm can be formed on the plate material 9 by using an ejection electrode 22b having a tip width of 20 μm, providing a distance of 1.0 mm between the ejection electrode 22b and the drum 11 as the counter electrode, and applying a voltage of 3 KV between these electrodes for 0.1 msec.

FIGS. 7 and 8 are a schematic cross-section view and a schematic front view, respectively, showing the vicinity of the ink ejection part in another example of the ejection head. In the Figures, 22 is an ejection head and this ejection head 22 has a first insulating substrate 33 having a tapered shape. Facing the first insulating substrate 33, a second insulating substrate 34 is provided with a clearance and at the distal end of the second insulating member 34, an inclined face part 35 is formed. The first and second insulating substrates each is formed of, for example, plastic, glass or ceramic. On the upper face part 36 making an acute angle with respect to the inclined face part 35 of the second insulating substrate 34, a plurality of ejection electrodes 22b are provided as electrostatic field-forming means of forming an electrostatic field in the ejection part. Respective tips of these multiple ejection electrodes 22b are extended to the vicinity of the distal end of the upper face part 36 and the tips each is projected ahead of the first insulating substrate 33 to form an ejection part. Between the first and second insulating substrates 33 and 34, an ink inflow path 37 is formed as means for feeding an ink 23 to the ejection part and in the lower side of the second insulating substrate 34, an ink recovery path 38 is formed. The ejection electrode 22b is formed on the second insulating substrate 34 in the same manner as above by a known method using an electrically conducting material such as aluminum, nickel, chromium, gold or platinum. Individual electrodes 22b are constructed to lie in an electrically insulated state from each other.

The tip of the ejection electrode 22b is preferably projected to a length of 2 mm or less from the distal end of the insulating substrate 33. The projection length is preferably within this range because if the projection length is excessively large, the ink meniscus does not reach the distal end of the ejection part, as a result, the ejection becomes difficult or the recording frequency decreases. The space between the first and second insulating substrates 33 and 34 is preferably from 0.1 to 3 mm. The space is preferably within this range because if the space is too small, the feed and in turn ejection of ink become difficult or the recording frequency decreases, whereas if the space is excessively large, the meniscus is not stabilized and the ejection becomes unstable.

The ejection electrode 22b is connected to the image data arithmetic and control part 21 and in performing the recording, a voltage is applied to the ejection electrode based on the image information, the ink on the ejection electrode is thereby ejected and an image is drawn on a plate material (not shown) disposed to face the ejection part. In the direction reverse to the ink droplet-ejecting direction of the ink inflow path 37, ink feed means of the ink feed device (not shown) is connected. On the surface opposite the ejection electrode-formed surface of the second insulating substrate 34, a backing 39 is provided to face the ejection electrode with a clearance. Between these, an ink recovery path 38 is provided. The ink recovery path 38 preferably has a space of 0.1 mm or more. The space is preferably within this range because if the space is too small, the recovery of ink becomes difficult and ink leakage may occur. The ink recovery path 38 is connected to ink recovery means of the ink feed device (not shown).

In the case where a uniform ink flow is necessary on the ejection part, a groove 40 may be provided between the ejection part and the ink recovery part. FIG. 8 is a schematic front view showing the vicinity of the ink ejection part of the ejection head. On the inclined face of the second insulating substrate 34, a plurality of grooves 40 are provided to extend from the vicinity of the boundary with the ejection electrode 22b toward the ink recovery passage 38. These multiple grooves 40 are aligned in the direction in which the ejection electrodes 22b are arrayed, and each has a function of introducing a constant amount of ink in the vicinity of the tip of the ejection electrode through the opening in the ejection electrode 22b side by a capillary force according to the opening diameter and discharging the introduced ink to the ink recovery path 38. Therefore, the grooves each has a function of forming an ink flow having a constant liquid thickness in the vicinity of the ejection electrode tip. The shape of the groove 40 may be sufficient if the capillary force can work, but the width is preferably from 10 to 200 μm and the depth is preferably from 10 to 300 μm. The grooves 40 are provided in the number necessary for forming a uniform ink flow throughout the surface of the ejection head.

With respect to the width of the ejection electrode 22b, the tip of the ejection electrode is preferably as narrow as possible for forming a high-quality image. The specific numerical value varies depending on the conditions such as applied voltage and physical properties of ink, however, the tip width is usually from 5 to 100 μm.

FIGS. 9 and 10 each is a view showing another example of the ejection head for use in practicing the present invention. FIG. 9 is a schematic view showing only a part of the head for the purpose of explanation. As shown in FIG. 9, the ejection head 22 comprises a head body 41 formed of an insulating material such as plastic, ceramic or glass, and meniscus regulating plates 42 and 42′. In the Figures, 22b is an ejection electrode for applying a voltage and thereby forming an electrostatic field in the ejection part. The head body is described in detail below by referring to FIG. 10 where the regulating plates 42 and 42′ are removed from the ejection head 22.

In the head body 41, a plurality of ink grooves 43 for circulating the ink are provided perpendicularly to the edge of the head body. The shape of the ink groove 43 may be sufficient if a capillary force can work to form a uniform ink flow, but the width is preferably from 10 to 200 μm and the depth is preferably from 10 to 300 μm. Inside the ink groove 43, an ejection electrode 22b is provided. This ejection electrode 22b may be disposed throughout or only on a part of the inner surface of the ink groove 43 of the head body 40 comprising an insulating material, similarly to the above-described case for the apparatus, by a known method using an electrically conducting material such as aluminum, nickel, chromium, gold or platinum. The ejection electrodes are electrically isolated from each other. One cell is formed by two adjacent ink grooves and in the center thereof, a partition 44 is disposed. At the distal end of the partition, ejection parts 45, 45′ are provided. The partition is reduced in the thickness and sharpened at the ejection parts 45, 45′ as compared with other parts of the partition 44. Such a head body is manufactured using an insulating material block by a known method such as mechanical processing, etching or molding. The thickness of the partition at the ejection part is preferably from 5 to 100 μm and the radius of curvature at the sharpened tip is preferably from 5 to 50 μm. The distal end of the ejection part may be slightly chamfered as shown by 45′. In the Figures where only two cells are shown, the cells are divided by a partition 46 and the distal end 47 thereof is chambered to recede than the ejection parts 45, 45′. An ink is flown into this ejection head through the ink groove from the I direction by the ink feed means of the ink feed device (not shown) to feed the ink to the ejection part. The excess ink is recovered toward the O direction by ink recovery means (not shown), whereby a fresh ink is always fed to the ejection part. In this sate, a voltage is applied to the ejection electrodes according to the image information, whereby an ink is ejected from the ejection parts to the drum (not shown) provided to face the ejection part and holding on the surface thereof a plate material, and an image is formed on the plate material.

Another example of the ejection head is described using FIG. 11. As shown in FIG. 11, the ejection head 22 has a pair of support members 50 and 50′ nearly in the rectangular shape. These support members 50 and 50′ are formed of a plate-like material having an insulating property, such as plastic, glass or ceramic, and having a thickness of 1 to 10 mm. On one surface of each support member, a plurality of rectangular grooves 51, 51′ extending in parallel to each other are formed according to the recording resolution. The grooves 51, 51′ each preferably has a width of 10 to 200 μm and a depth of 10 to 300 μm. Throughout or on a part of the inside thereof, an ejection electrode 22 is formed. By forming a plurality of grooves 51, 51′ on one surface of each support 50, 50′ as such, a plurality of rectangular partitions 52 are necessarily provided between respective grooves 51. The support members 50 and 50′ are combined such that the surfaces having not provided thereon the grooves 51, 51′ face each other. Namely, the ejection head 22 has a plurality of grooves for passing an ink on the outer circumferential surface thereof. The grooves 51 and 51′ formed on respective support members 50 and 50′ are connected through the rectangular part 54 of the ejection head 22 to correspond one by one. The rectangular parts 54 resultant from the combining of respective grooves each recedes to a predetermined distance (from 50 to 500 μm) from the upper end 53 of the ejection head 22. In other words, the upper end 55 of each partition 52 in both sides of each rectangular part 54 of respective support members 50 and 50′ projects from the rectangular part 54. On each rectangular part 54, a guide projection 56 comprising an insulating material described above is provided to project therefrom, thereby forming an ejection part.

In the case of circulating an ink to the thus-constructed ejection head 22, an ink is fed to each rectangular part 54 through each groove 51 formed on the outer circumferential surface of one support member 50 and discharged through each groove 51′ formed on the support member 50′ in the opposite side. In this case, the ejection head 22 is inclined at a predetermined angle so as to enable smooth flow of the ink. That is, the ejection head 22 is inclined such that the ink feed side (support member 50) is positioned upward and the ink discharge side (support member 50′) is positioned downward. When an ink is circulated to the ejection head 22 as such, the ink passing through each rectangular part 54 comes to full wetting along each projection 56, and an ink meniscus is formed in the vicinity of the rectangular part 54 and the projection 56. In this state where ink meniscuses are formed independently from each other on respective rectangular parts 54, a voltage is applied to the ejection electrode 22b based on the image information, as a result, an ink is ejected from the ejection part toward the drum (not shown) provided to face the ejection part and holding on the surface thereof a plate material, whereby an image is formed on the plate material. Here, a cover for covering the grooves may be provided on the outer circumferential surface of each support member 50, 50′ to form a pipe-like ink flow path on the outer circumferential surface of each support member 50, 50′ and thereby forcedly circulate the ink through this ink flow path. In this case, the ejection head 22 needs not be inclined.

The ejection head 22 described above using FIGS. 5 to 11 may contain a maintenance device such as cleaning means, if desired. For example, in the case where the dormant state continues or where a trouble is generated in the image quality, means for wiping off the ejection head tip with a material having flexibility, such as scrub, brush or cloth, means for circulating only the ink solvent, means for feeding only the ink solvent and means for sucking the ejection part while performing the circulation, may be used individually or in combination and by using these means, good drawing state can be maintained. For preventing the solidification of ink, it is effective to cool the head part and thereby suppress the evaporation of ink solvent. In the case where the contamination is more sticking, for example, a method of enforcedly sucking the ink from the ejection part, a method of enforcedly jetting an air, ink or ink solvent through the ink flow path, a method of applying an ultrasonic wave while dipping the head in an ink solvent are also effective and these methods may be used individually or in combination.

The second embodiment of the present invention is described in detail below.

The present invention is characterized in that an image is formed on a plate material (printing plate precursor) provided on a plate cylinder of a press by an ink jet process of ejecting an oil ink from the recording head using an electrostatic field.

The ink jet process for use in the present invention is described in PCT Publication WO93/11866. In this ink jet process, an ink having high resistance obtained by dispersing resin particles which are solid and hydrophobic at least at ordinary temperatures, in an insulating solvent is used, a strong electric field is allowed to act on this ink at the ejection position to form an aggregate of resin particles at the ejection position, and the aggregate is ejected from the ejection position using electrostatic means. In this way, the resin particles are ejected as an aggregate formed to a high concentration and therefore, the printed dots can have a sufficiently large thickness, as a result, the image of aggregated resin particles formed on the plate material as a recording medium can have sufficiently long press life.

In this ink jet process, the size of the ink droplet ejected is determined by the size of the tip of the ejection electrode or the conditions in forming the electric field. Accordingly, a small ink droplet can be obtained without reducing the ejection nozzle size or slit width and the dot size on the plate material can be controlled by controlling the conditions in forming an electric field.

Therefore, according to the present invention, a fine image having a sufficiently long press life can be controlled without causing any problem of ink clogging in the head and a large number of printed matters having a clear image can be printed.

One construction example of the on-press drawing lithographic printing apparatus for use in practicing the lithographic printing method of the present invention is described below.

FIG. 2-1 is an entire construction view of an on-press drawing one-color one-side lithographic printing apparatus. FIG. 2-2 is a view schematically showing a construction example of the drawing part of this on-press drawing lithographic printing apparatus including the control part, the ink feed part and the head-retreating or approximating mechanism. FIGS. 2-3 to 2-9 are views for explaining the ink jet recording device of the on-press drawing lithographic printing apparatus of FIGS. 2-1 and 2-10. FIG. 2-10 is a view showing an entire construction example of an on-press drawing four-color one-side lithographic printing apparatus according to the present invention.

The printing process according to the present invention is described below using the entire construction view of an on-press one-color one-side lithographic printing machine shown in FIG. 2-1. As shown in FIG. 2-1, the on-press drawing lithographic printing apparatus 2-1 (hereinafter sometimes simply referred to as a “printing apparatus”) has one plate cylinder 2-11, one blanket cylinder 2-12 and one impression cylinder 2-13. These cylinders are disposed such that at least at the time of performing the lithographic printing, the blanket cylinder 2-12 for transfer is pressed against the plate cylinder 2-11 and the impression cylinder 2-13 is pressed against the blanket cylinder 2-12 for transferring the printing ink image transferred on the blanket cylinder to a printing paper sheet P.

The plate cylinder 2-11 is usually made of a metal and the surface thereof is subjected to, for example, chromium plating so as to strengthen the abrasion resistance but the plate cylinder may have a heat insulating material on the surface thereof as described later. The plate cylinder 2-11 acts as a counter electrode of the recording head electrode at the electrostatic ejection and therefore, is preferably earthed. In the case where the substrate of the plate material has high insulating property, an electrically conducting layer is preferably provided on the substrate and in this case, means for taking the earth from this electrically conducting layer to the plate cylinder is preferably provided. Also in the case of providing a heat insulating material on the plate cylinder, means for taking earth from the plate material is provided to facilitate the drawing. In this case, known means having electrical conductivity, such as brush, leaf spring or roller may be used.

The printing apparatus 2-1 further has an ink jet recording device (ink jet drawing device) 2-2 which ejects an oil ink on the plate material 2-9 attached to the plate cylinder 2-11 in correspondence to the image data sent from an image data arithmetic and control part 2-21 and forms an image.

In the printing apparatus 2-1, a fountain solution feed device 2-3 of feeding a fountain solution to the hydrophilic part (non-image area) on the plate material 2-9 is provided. FIG. 2-1 shows an apparatus using a Morton water feed system which is a representative example of the fountain solution feed device 2-3, however, other known devices such as SHINFLO water feed system and continuous water feed system may also be used for the fountain solution feed device 2-3.

The printing apparatus 2-1 further has a printing ink feed device 2-4 and a fixing device 2-5 for strengthening the oil ink image drawn on the plate material 2-9. If desired, a plate surface desensitizing device 2-6 may also be provided for intensifying the hydrophilicity on the surface of the plate material 2-9.

The printing apparatus 2-1 further has plate material surface dust-removing means 2-10 of removing dusts present on the surface of the plate material before and/or during the drawing on the plate material. By this means, the ink can be effectively prevented from adhering to the plate material by the help of dusts invaded between the head and the plate material during the plate-making and thereby, good plate-making can be attained. For the dust-removing means, a known non-contact method such as suction removal, blowing removal or electrostatic removal, or a contact method by a brush, a roller or the like may be used. In the present invention, air suction, air blowing or a combination thereof is preferably used. In this case, an air pump usually used in a paper feed device can be used to this purpose.

In addition, an automatic plate feed device 2-7 of automatically feeding a plate material 2-9 to be used in printing, onto the plate cylinder 2-11 and an automatic plate discharge device 2-8 of automatically removing the plate material 2-9 from the plate cylinder 2-11 after the completion of printing may be provided. Examples of the printing machine having these devices known as auxiliary devices of a printing machine include Hamada VS34A, B452A (manufactured by Hamada Insatsu Kikai K.K.), TOKOH 8000PFA (manufactured by Tokyo Koku Keiki K.K.), Ryobi 3200ACD, 3200PFA (manufactured by Ryobi Imagisk K.K.), AMSIS Multi5150F.A (manufactured by Nippon AM K.K.), Oliver 266EPZ (manufactured by Sakurai Graphic Systems K.K.) and Shinohara 66IV/IVP (manufactured by Shinohara Shoji K.K.). Furthermore, a blanket cleaning device 2-14 and an impression cylinder cleaning device 2-14′ may also be provided. By using these devices 2-7, 2-8, 2-14 and 2-14′, the printing operation is more facilitated and the printing time can be shortened, as a result, the effect of the present invention can be more enhanced. In the vicinity of the impression cylinder 2-13, a paper dust generation-preventing device (paper dust-removing means) 2-15 may be further provided so as to prevent paper dusts from adhering to the plate material. The paper dust generation-preventing device 2-15 may employ humidity control, suction by air or electrostatic force, or the like.

The image data arithmetic and control part 2-21 receives image data from an image scanner, a magnetic disc device, an image data transmission device or the like, performs color separation and at the same time, partitions and computes the separated data into an appropriate number of picture elements or an appropriate number of gradations. Furthermore, since the oil ink image is drawn as a dotted image using an ink jet recording head 2-22 (which is described in detail later; see, FIG. 2-2) as a recording head of the ink jet recording device 2-2, the halftone dot area factor is also computed.

In addition, as described later, the image data arithmetic and control part 2-21 controls the movement of the ink jet recording head 2-22, the timing of ejecting the oil ink and if desired, the timing of operating the plate cylinder 2-11, the blanket cylinder 2-12, the impression cylinder 2-13 and the like.

The process of preparing a printing plate by the printing apparatus 2-1 is described below by referring to FIG. 2-1 and partially to FIG. 2-2.

A plate material 2-9 is attached to the plate cylinder 2-11 using an automatic plate feed device 2-7. At this time, the plate material is tightly fixed on the plate cylinder by a known mechanical method or electrostatic method using a plate head/edge gripping device, an air suction device or the like, whereby the edge of plate can be prevented from fluttering to come into contact with the ink jet recording device 2-2 and case damages during the drawing. Furthermore, means of tightly contacting the plate material to the plate cylinder only in the periphery of the drawing position of the ink jet recording device may be provided and by actuating this at least at the time of performing the drawing, the plate material can also be prevented from contacting with the ink jet recording device. To speak specifically, for example, a method of disposing a presser roller upstream and downstream the drawing position of the plate cylinder may be used.

Also, means of preventing the plate edge from contacting with an ink feed roller in the process of fixing the plate may be provided, whereby the plate surface can be prevented from staining and the loss paper can be reduced. Specifically, a presser roller, a guide, electrostatic adsorption or the like is effective.

The image data from a magnetic disk device or the like is given to an image data arithmetic and control part 2-21 and according to the input image data, the image data arithmetic and control part 2-21 computes the position of ejecting an oil ink and the halftone dot area factor at that position. These computed data are once stored in a buffer. The image data arithmetic and control part 2-21 rotates the plate cylinder 2-11 and approximates the recording head 2-22 to the position proximate to the plate cylinder 2-11 using a head-retreating or approximating device (recording head-retreating or approximating means) 2-31. The recording head 2-22 and the surface of the plate material 2-9 on the plate cylinder 2-11 are kept at a predetermined distance during the drawing under mechanical distance control using a knock roller or the like, or under control of the head-retreating or approximating device based on the signals from an optical distance detector. By this distance control, good plate-making can be attained without causing non-uniformity in the dot size due to floating of the plate material or particularly without causing any change in the dot size even when vibration is applied to the printing machine.

For the recording head 2-22, a single channel head, a multi-channel head or a full line head may be used and the main scanning is performed by the rotation of the plate cylinder 2-11. In the case of a multi-channel head having a plurality of ejection parts or a full line head, the direction in which the ejection parts are arrayed is set to the axial direction. Furthermore, in the case of a single channel head or a multi-channel head, the head 2-22 is moved in the direction parallel to the axis of the plate cylinder by the image data arithmetic and control part 2-21 every each rotation of the plate cylinder 2-11 and an oil ink is ejected to the plate material 2-9 attached to the plate cylinder 2-11 based on the ejection position and halftone dot area factor obtained by the computation. By this ejection, a halftone image is drawn on the plate material 2-9 by the oil ink according to the variable density of the printing original. This operation continues until an oil ink image of one color portion of the printing original is formed on the plate material 2-9 and thereby, a printing plate is finished.

On the other hand, in the case where the recording head 2-22 is a full line head having almost the same length as the width of the plate cylinder, an oil ink image of one color portion of the printing original is formed on the plate material 2-9 by one rotation of the plate cylinder and thereby, a printing plate is finished. Since the main scanning is performed as such by the rotation of the plate cylinder, the positional precision in the main scanning direction can be enhanced and high-speed drawing can be performed.

The recording head 2-22 is then retreated to come apart from the position proximate to the plate cylinder 2-11 so as to protect the recording head 2-22. At this time, only the recording head 2-22 may be retreated but the recording head 2-22 and the head sub-scanning means 2-32 together or the recording head 2-22, the ink feed part 2-24 and the head sub-scanning means 2-32 all may be retreated. Together with the recording head 2-22, the ink feed part 2-24 and the head sub-scanning means 2-32, the fixing device 2-5 and the dust-removing means 2-10 each may be retreated by having a retreating or approximating means, whereby normal printing can also be performed.

This retreating or approximating means is operated to separate the recording head at least 500 μm or more apart from the plate cylinder except for the drawing time. The retreating or approximating operation may be performed by a slide system or in a pendulum manner by fixing the head using an arm fixed to a certain axis and moving the arm around the axis. By retreating the head as such at the non-drawing time, the head can be protected from the physical breakage or contamination and can have a long life.

The oil ink image formed is strengthened under heating or the like in the fixing device 2-5. For the ink fixing means, known means such as heat fixing, solvent fixing and flash exposure fixing may be used. In the heat fixing, hot air fixing by the irradiation of an infrared lamp, a halogen lamp or a xenon flash lamp or using a heater, or heat roll fixing is generally employed. In this case, the fixing property can be effectively enhanced by using means of heating the plate cylinder, means of preheating the plate material, means of performing the drawing while applying hot air, means of coating the plate cylinder with a heat insulating material or means of heating only the plate material by separating the plate material from the plate cylinder only at the fixing, and these means can be used individually or in combination. The flash fixing using a xenon lamp or the like is known as a fixing method of electrophotographic toner and this is advantageous in that the fixing can be performed within a short time. In the solvent fixing, a solvent capable of dissolving the resin components in the ink, such as methanol or ethyl acetate, is sprayed and excess solvent vapor is recovered.

At least in the process from the formation of an oil ink image by the recording head 2-22 until the fixing by the fixing device 2-5, the fountain solution feed device 2-3, the printing ink feed device 2-4 and the blanket cylinder 2-12 are preferably kept not to come into contact with the plate material 2-9 on the plate cylinder.

The printing process after the formation of the printing plate is the same as that in known lithographic printing methods. More specifically, a printing image is formed by supplying a printing ink and a fountain solution are given to the plate material 2-9 having drawn thereon an oil ink image, the printing ink image formed is transferred to a blanket cylinder 2-12 rotating together with the plate cylinder 2-11 and subsequently, the printing ink image on the blanket cylinder 2-12 is transferred to a printing paper sheet P passing between the blanket cylinder 2-12 and the impression cylinder 2-13, thereby performing printing of one color portion. After the completion of printing, the plate material 2-9 is removed from the plate cylinder 2-11 by the automatic plate discharge device 2-8 and the blanket on the blanket cylinder 2-12 is cleaned by the blanket cleaning device 2-14 to provide a state ready for next printing.

The ink jet recording device 2-2 is described in detail below.

As shown in FIG. 2-2, the drawing part for use in the plate-making apparatus comprises an ink jet recording device 2-2 and an ink feed part 2-24. The ink feed part 2-24 further comprises an ink tank 2-25, an ink feed device 2-26 and ink concentration-controlling means 2-29 and in the ink tank 2-25, ink stirring means 2-27 and ink temperature-controlling means (means for controlling the temperature of ink) 2-28 are contained. The ink may be circulated in the recording head as shown in FIG. 2-11 (which is described later) and in this case, the ink feed part 2-24 additionally has a recovery and circulating function. The ink stirring means 2-27 prevents the precipitation and coagulation of solid contents in the ink and reduces the need for cleaning of the ink tank. For the in stirring means, a rotary blade, a piezoelectric transducer and a circulation pump may be used and these are used individually or in combination. The ink temperature-controlling means 2-28 is disposed such that the physical property of ink or the dot size does not vary due to change in the ambient temperature and a high-quality image can be stably formed. For the ink temperature-controlling means, a known method may be used, for example, a method of disposing a heat-generating element or a cooling element such as heater or Peltier device within the ink tank together with the stirring means and keeping constant the temperature distribution within the tank under control by a temperature sensor such as thermostat. The ink temperature within the ink tank is preferably from 15 to 60° C., more preferably from 20 to 50° C. The stirring means of keeping constant the temperature distribution within the tank may be used in common as the above-described ink stirring means for the purpose of preventing the precipitation/coagulation of solid components in the ink.

As shown in FIG. 2-11, the ink feed device 2-24 may be designed such that the ink is circulated inside the head. The ink feed part has, as shown in FIG. 2-11, a recovery and circulating function of circulating and recovering the ink from the head 2-22 by a pump 2-26′ and a valve 2-61′. Furthermore, filtering means such as filter is disposed immediately before the ejection head 2-22, whereby a more clean ink free of paper fiber or dusts can be fed to the ejection head 22.

This printing apparatus of the present invention has ink concentration-controlling means 29 for drawing a high-quality image. By having this means, generation of bleeding on the plate or slipping or thinning of the printing image due to reduction in the solid concentration of the ink, or change in the dot size on the plate due to increase in the solid concentration, can be effectively prevented. The ink concentration is controlled by measuring the physical properties using, for example, optical detection or measurement of electrical conductivity or viscosity, or by counting the number of plates subjected to the drawing. In the case of controlling the ink concentration by measuring the physical properties, an optical detector, an electrical conductivity-measuring meter and a viscosity-measuring meter are provided individually or in combination within the ink tank or on the flow path of ink and according to the output signals thereof, the concentration of ink is controlled. In the case of controlling the ink concentration by counting the number of plates subjected to the drawing, the feed of liquid to the ink tank from a concentrated ink tank for replenishment (not shown) or from a diluting ink carrier tank is controlled by the number of plates manufactured and the frequency of plate-making.

The image data arithmetic and control part 2-21 computes the input image data and moves the head using a head-retreating or approximating device 2-31 or head sub-scanning means 2-32 as described above and additionally, takes in the timing pulse from an encoder 2-30 disposed in the plate cylinder and drives the head according to the timing pulse. By this, the positional precision in the sub-scanning direction is enhanced. The positional precision in the sub-scanning direction at the time of performing the drawing by the ink jet recording device can also be enhanced by driving the plate cylinder using high-precision driving means different from the driving means used at the printing. In this case, it is preferred to mechanically separate the driving means from the blanket cylinder, the impression cylinder and others and drive only the plate cylinder. To speak more specifically, for example, a method of reducing the output from a high-precision motor by a high-precision gear, a steel belt or the like and driving only the plate cylinder may be used. In performing a high-quality drawing, these means are used individually or in combination.

The recording head is described below using FIGS. 2-3 to 2-9, however, the present invention is not limited the following embodiment.

FIGS. 2-3 and 2-4 each is a view showing one example of the head provided in the ink jet recording device. The head 2-22 has a slit sandwiched by an upper unit 2-221 and a lower unit 2-222 each composed of an insulating base material, and the distal end of the slit works out to an ejection slit 2-22a. Within the slit, an ejection electrode 2-22b is disposed and the slit is filled with an ink 2-23 fed from the ink feed device. Examples of the insulating base material which can be used include plastics, glass and ceramics. The ejection electrode 2-22b is formed by a known method such as a method of subjecting the lower unit 2-222 composed of an insulating base material to vapor deposition, sputtering or electroless plating with an electrically conductive material such as aluminum, nickel, chromium, gold or platinum, coating a photoresist thereon, exposing the photoresist through a predetermined electrode pattern mask, developing it to form a photoresist pattern of the ejection electrode 2-22b and etching the pattern, a method of mechanically removing the photoresist pattern or a method comprising a combination thereof.

In the head 2-22, a voltage is applied to the ejection electrode 2-22b according to digital signals of the image pattern. As shown in FIG. 2-3, a plate cylinder 2-11 which works out to a counter electrode is provided to face the ejection electrode 2-22b and on the plate cylinder 2-11 as the counter electrode, a plate material 2-9 is provided. When a voltage is applied, a circuit is formed between the ejection electrode 2-22b and the plate cylinder 2-11 as the counter electrode, then, an oil ink 2-23 is ejected from the ejection slit 2-22a of the head 2-22 to form an image on the plate material 2-9 provided on the plate cylinder 2-11 as the counter electrode.

With respect to the width of the ejection electrode 2-22b, the tip thereof is preferably as narrow as possible for forming a high-quality image. The specific numerical value varies according to the conditions such as applied voltage and physical properties of ink, but the tip width is usually from 5 to 100 μm.

For example, a dot of 40 μm can be formed on the plate material 2-9 by using an ejection electrode 2-22b having a tip width of 20 μm, providing a distance of 1.0 mm between the ejection electrode 2-22b and the plate cylinder 2-11 as the counter electrode, and applying a voltage of 3 KV between these electrodes for 0.1 msec.

FIGS. 2-5 and 2-6 are a schematic cross-section view and a schematic front view, respectively, showing the vicinity of the ink ejection part in another example of the recording head. In the Figures, 2-22 is a recording head and this recording head 2-22 has a first insulating substrate 2-33 having a tapered shape. Facing the first insulating substrate 2-33, a second insulating substrate 2-34 is provided with a clearance and at the distal end of the second insulating member 2-34, an inclined face part 2-35 is formed. The first and second insulating substrates each is formed of, for example, plastic, glass or ceramic. On the upper face part 2-36 making an acute angle with respect to the inclined face part 2-35 of the second insulating substrate 2-34, a plurality of ejection electrodes 2-22b are provided as electrostatic field-forming means of forming an electrostatic field in the ejection part. Respective tips of these multiple ejection electrodes 2-22b are extended to the vicinity of the distal end of the upper face part 2-36 and the tips each is projected ahead of the first insulating substrate 2-33 to form an ejection part. Between the first and second insulating substrates 2-33 and 2-34, an ink inflow path 2-37 is formed as means for feeding an ink 2-23 to the ejection part and in the lower side of the second insulating substrate 2-34, an ink recovery path 2-38 is formed. The ejection electrode 2-22b is formed on the second insulating substrate 2-34 in the same manner as above by a known method using an electrically conducting material such as aluminum, nickel, chromium, gold or platinum. Individual electrodes 22b are constructed to lie in the electrically insulated state from each other.

The tip of the ejection electrode 2-22b is preferably projected to the length of 2 mm or less from the distal end of the insulating substrate 2-33. The projection length is preferably within this range because if the projection length is excessively large, the ink meniscus does not reach the distal end of the ejection part, as a result, the ejection becomes difficult or the recording frequency decreases. The space between the first and second insulating substrates 2-33 and 2-34 is preferably from 0.1 to 3 mm. The space is preferably within this range because if the space is too small, the feed and in turn ejection of ink become difficult or the recording frequency decreases, whereas if the space is excessively large, the meniscus is not stabilized and the ejection becomes unstable.

The ejection electrode 2-22b is connected to the image data arithmetic and control part 2-21 and in performing the recording, a voltage is applied to the ejection electrode based on the image information, whereby the ink on the ejection electrode is ejected and an image is drawn on a plate material (not shown) disposed to face the ejection part. In the direction reverse to the ink droplet-ejecting direction of the ink inflow path 2-37, ink feed means of the ink feed device (not shown) is connected. On the surface opposite the ejection electrode-formed surface of the second insulating substrate 2-34, a backing 2-39 is provided to face the ejection electrode with a clearance. Between these, an ink recovery passage 2-38 is provided. The ink recovery path 2-38 preferably has a space of 0.1 mm or more. The space is preferably within this range because if the space is too small, the recovery of ink becomes difficult and ink leakage may occur. The ink recovery path 2-38 is connected to ink recovery means of the ink feed device (not shown).

In the case where a uniform ink flow is necessary on the ejection part, a groove 2-40 may be provided between the ejection part and the ink recovery path. FIG. 2-6 is a schematic front view showing the vicinity of the ink ejection part of the recording head. On the inclined face of the second insulating substrate 2-34, a plurality of grooves 2-40 are provided to extend from the vicinity of the boundary with the ejection electrode 2-22b toward the ink recovery path 2-38. These multiple grooves 2-40 are aligned in the direction in which the ejection electrodes 22b are arrayed and each has a function of introducing a constant amount of ink in the vicinity of the tip of the ejection electrode through the opening in the ejection electrode 2-22b side by a capillary force according to the opening diameter and discharging the introduced ink to the ink recovery path 2-38. Therefore, the grooves each has a function of forming an ink flow having a constant liquid thickness in the vicinity of the ejection electrode tip. The shape of the groove 2-40 may be sufficient if the capillary force can work, but the width is preferably from 10 to 200 μm and the depth is preferably from 10 to 300 μm. The grooves 2-40 are provided in the number necessary for forming a uniform ink flow throughout the surface of the head.

With respect to the width of the ejection electrode 2-22b, the tip of the ejection electrode is preferably as narrow as possible for forming a high-quality image. The specific numerical value varies depending on the conditions such as applied voltage and physical properties of ink, however, the tip width is usually from 5 to 100 μm.

FIGS. 2-7 and 2-8 each is a view showing another example of the recording head for use in practicing the present invention. FIG. 2-7 is a schematic view showing only a part of the head for the purpose of explanation. As shown in FIG. 2-7, the recording head 2-22 comprises a head body 2-41 formed of an insulating material such as plastic, ceramic or glass, and meniscus regulating plates 2-42 and 2-42′. In the Figures, 2-22b is an ejection electrode for applying a voltage and thereby forming an electrostatic field in the ejection part. The head body is described in detail below by referring to FIG. 2-8 where the regulating plates 2-42 and 2-42′ are removed from the head.

In the head body 2-41, a plurality of ink grooves 2-43 for circulating the ink are provided perpendicularly to the edge of the head body. The shape of the ink groove 2-43 may be sufficient if a capillary force can work to form a uniform ink flow, but the width is preferably from 10 to 200 μm and the depth is preferably from 10 to 300 μm. Inside the ink groove 2-43, an ejection electrode 2-22b is provided. This ejection electrode 2-22b may be provided throughout or only on a part of the inner surface of the ink groove 2-43 of the head body 2-40 comprising an insulating material, similarly to the above-described case for the apparatus, by a known method using an electrically conducting material such as aluminum, nickel, chromium, gold or platinum. The ejection electrodes are electrically isolated from each other. One cell is formed by two adjacent ink grooves and in the center thereof, a partition 2-44 is disposed. At the distal end of the partition, ejection parts 2-45, 2-45′ are provided. The partition is reduced in the thickness and sharpened at the ejection parts 2-45, 2-45′ as compared with other parts of the partition 2-44. Such a head body is manufactured using an insulating material block by a known method such as mechanical processing, etching or molding. The thickness of the partition at the ejection part is preferably from 5 to 100 μm and the radius of curvature at the sharpened tip is preferably from 5 to 50 μm. The distal end of the ejection part may be slightly chamfered as shown by 2-45′. In the Figures where only two cells are shown, the cells are divided by a partition 2-46 and the distal end 2-47 thereof is chambered to recede than the ejection parts 2-45, 2-45′. An ink is flown into this head through the ink groove from the I direction by the ink feed means of the ink feed device (not shown) to feed the ink to the ejection part. The excess ink is recovered toward the O direction by ink recovery means (not shown), whereby a fresh ink is always fed to the ejection part. In this sate, a voltage is applied to the ejection electrodes according to the image information, then, an ink is ejected from the ejection parts to the plate cylinder (not shown) provided to face the ejection part and holding on the surface thereof a plate material, whereby an image is formed on the plate material.

Another example of the recording head is described using FIG. 2-9. As shown in FIG. 2-9, the recording head 2-22 has a pair of support members 2-50 and 2-50′ nearly in the rectangular shape. These support members 2-50 and 2-50′ are formed of a plate-like material having an insulating property, such as plastic, glass or ceramic, and having a thickness of 1 to 10 mm. On one surface of each support member, a plurality of rectangular grooves 2-51, 2-51′ extending in parallel to each other are formed according to the recording resolution. The grooves 2-51, 2-51′ each preferably has a width of 10 to 200 μm and a depth of 10 to 300 μm. Throughout or on a part of the inside thereof, an ejection electrode 2-22b is formed. By forming a plurality of grooves 2-51, 2-51′ on one surface of each support 2-50, 2-50′ as such, a plurality of rectangular partitions 2-52 are necessarily provided between respective grooves 2-51. The support members 2-50 and 2-50′ are combined such that the surfaces having not provided thereon the grooves 2-51, 2-51′ face each other. Namely, the recording head 2-22 has a plurality of grooves for passing an ink on the outer circumferential surface thereof. The grooves 2-51 and 2-51′ formed on respective support members 2-50 and 2-50′ are connected through the rectangular part 2-54 of the recording head 2-22 to correspond one by one. The rectangular parts 2-54 resultant from the combining of respective grooves each recedes to a predetermined distance (from 50 to 500 μm) from the upper end 2-53 of the recording head 2-22. In other words, the upper end 2-55 of each partition 2-52 in both sides of each rectangular part 2-54 of respective support members 2-50 and 2-50′ projects from the rectangular part 2-54. On each rectangular part 2-54, a guide projection 2-56 comprising an insulating material described above is provided to project therefrom, thereby forming an ejection part.

In the case of circulating an ink to the thus-constructed recording head 2-22, an ink is fed to each rectangular part 2-54 through each groove 2-51 formed on the outer circumferential surface of one support member 2-50 and discharged through each groove 2-51′ formed on the support member 2-50′ in the opposite side. In this case, the recording head 2-22 is inclined at a predetermined angle so as to enable smooth flow of the ink. That is, the recording head 2-22 is inclined such that the ink feed side (support member 2-50) is positioned upward and the ink discharge side (support member 2-50′) is positioned downward. When an ink is circulated to the recording head 2-22, the ink passing through each rectangular part 2-54 comes to full wetting along each projection 2-56, and an ink meniscus is formed in the vicinity of the rectangular part 2-54 and the projection 2-56. In this state where ink meniscuses are formed independently from each other on respective rectangular parts 2-54, a voltage is applied to the ejection electrode 2-22b based on the image information, then, an ink is ejected from the ejection part toward the plate cylinder (not shown) provided to face the ejection part and holding on the surface thereof a plate material, whereby an image is formed on the plate material. Here, a cover for covering the grooves may be provided on the outer circumferential surface of each support member 2-50, 2-50′ to form a pipe-like ink flow path on the outer circumferential surface of each support member 2-50, 2-50′ and thereby forcedly circulate the ink through this ink flow path. In this case, the recording head 2-22 needs not be inclined.

The head 2-22 shown in FIGS. 2-3 to 2-9 may contain a maintenance device such as cleaning means, if desired. For example, in the case where the dormant state continues or where a trouble is generated in the image quality, means for wiping off the recording head tip with a material having flexibility, such as scrub, brush or cloth, means for circulating only the ink solvent, means for feeding only the ink solvent and means for sucking the ejection part while performing the circulation, may be used individually or in combination, whereby good drawing state can be maintained. For preventing the solidification of ink, it is effective to cool the head part and thereby suppress the evaporation of ink solvent. In the case where the contamination is more sticking, for example, a method of enforcedly sucking the ink from the ejection part, a method of enforcedly jetting an air, ink or ink solvent through the ink flow path, a method of applying an ultrasonic wave while dipping the head in an ink solvent are also effective and these methods may be used individually or in combination.

An on-press drawing multicolor one-side lithographic printing apparatus, which is a specific example of the present invention, is described below.

FIG. 2-10 shows an entire construction example of an on-press drawing four-color one-side lithographic cut sheet printing apparatus. As shown in FIG. 2-10, the four-color one-side lithographic cut sheet printing apparatus fundamentally has a structure such that the plate cylinder 2-11, the blanket cylinder 2-12 and the impression cylinder 2-13 of a one-color one-side printing apparatus shown in FIG. 2-1 each is disposed in four units and the printing is performed on the same surface of a printing paper sheet P. The delivery of the printing paper sheet between adjacent impression cylinders, shown by K in the figure, is performed using a known cylinder transfer system or the like (not shown). As easily understood from the example of FIG. 2-10, other multicolor one-side printing apparatuses fundamentally have a structure such that the plate cylinder 1-11, the blanket cylinder 2-12 and the impression cylinder 2-13 of the one-color one-side printing apparatus each is disposed in multiple units and the printing is performed on the same surface of a printing paper sheet P, though these are not described in detail here. In the case of manufacturing only one color portion plate on the plate cylinder, the plate cylinder and the blanket cylinder each is disposed in the number of units corresponding to the number of colors used for the printing (such a printing apparatus is called a unit-type printing apparatus). On the other hand, in the case of practicing the present invention by a common impression cylinder-type printing apparatus using in common one impression cylinder having a diameter as large as integral times the diameter of the plate cylinder while having the plate cylinder and the blanket cylinder each in the number of units corresponding to the multiple color portions, the printing apparatus may have a structure such that the plate cylinder and the blanket cylinder each in the number of units corresponding to the multiple color portions to be printed use one impression cylinder in common or such that a plurality of structures using one impression cylinder in common by the plate cylinder and the blanket cylinder each in the number of units corresponding to multiple color portions are provided and the total number of each of the plate cylinder and the blanket cylinder corresponds to the number of color portions printed. In this case, the delivery of the printing paper sheet between adjacent common impression cylinders may be performed by the above-described known cylinder transfer system.

In the case of manufacturing plates of multiple colors on a plate cylinder, the plate cylinder and the blanket cylinder each must be provided in the number of units corresponding to the value obtained by dividing the number of colors printed by the number of plates on one plate cylinder. For example, in the case of manufacturing plate materials of two color portions on a plate cylinder, one-side four-color printing can be performed by a printing apparatus having two plate cylinders and two blanket cylinders. In this case, the diameter of the impression cylinder is the same as the size of the plate cylinder of one color portion, means for holding the printing paper sheet until the completion of printing of necessary color portions is provided to the impression cylinder, if desired, and the delivery of the printing paper sheet between impression cylinders is performed using a known cylinder transfer system. In the case of the above-described press having two plate cylinders having manufactured thereon plate materials of two color portions and having two blanket cylinders, one impression cylinder rotates twice while holding a printing paper sheet to perform two-color printing, the printing paper sheet is delivered between impression cylinders, and the other impression cylinder rotates twice while holding the printing paper sheet to perform two-color printing, thereby completing four-color printing. The number of impression cylinders may be the same as the number of plate cylinders but some plate cylinders and some blanket cylinders may use one impression cylinder in common.

In the case of practicing the present invention as an on-press drawing multicolor two-side lithographic cut sheet printing apparatus, the printing apparatus has a structure such that known printing paper-reversing means is provided at least in one space between adjacent impression cylinders of the above-described unit-type printing apparatus, a structure such that a plurality of common impression cylinder-type printing apparatuses are disposed and known printing paper-reversing means is provided at least in one space between adjacent impression cylinders, or a structure such that the plate cylinder 2-11 and the blanket cylinder 2-12 of the one-color one-side printing apparatus shown in FIG. 2-1 are disposed in multiple units to perform the printing on both surfaces of the printing paper sheet P. In the structure shown in FIG. 2-1, when only a plate of one color portion is manufactured on the plate cylinder, the plate cylinder and the blanket cylinder are provided in the number of units corresponding to the number of colors necessary for the printing on both surfaces of a printing paper sheet. On the other hand, when plates of multiple colors are manufactured on the plate cylinder as described above, the numbers of plate cylinders, blanket cylinders and impression cylinders can be reduced. Furthermore, when one impression cylinder is used in common by some plate cylinders and some blanket cylinders, the number of impression cylinders can be more reduced. If desired, means of holding the printing paper sheet until the completion of printing of necessary color portions is provided on the impression cylinder. This can be easily understood from the above-described example of an on-press drawing multicolor one-side lithographic printing machine and therefore, details thereon are omitted here.

As such, an example of a cut sheet printing apparatus is described as a practical embodiment of the on-press drawing multicolor lithographic printing apparatus of the present invention. In the case of practicing the present invention as an on-press drawing multicolor WEB (rolled paper) lithographic printing apparatus, the above-described unit type or common impression cylinder type can be suitably used. Furthermore, in the case of practicing the present invention as an on-press drawing multicolor WEB two-side printing apparatus, this can be achieved in both the unit type and the common impression cylinder type by having a structure such that known WEB-reversing means is provided at least in one space between adjacent impression cylinders or a structure such that a plurality of such means are provided so as to perform the printing on both surface of the printing paper sheet P. The on-press drawing multicolor WEB two-side printing apparatus is most suitably a BB (blanket-to-blanket) type printing apparatus where a structure having a plate cylinder of one color portion and a blanket cylinder (no impression cylinder) for performing the printing on one surface of WEB, and a plate cylinder of one color portion and a blanket cylinder (no impression cylinder) for performing the printing on another surface and press-contacting the blanket cylinders with each other at the printing, is provided in the number of units corresponding to the number of colors and the WEB is passed through between press-contacted blankets at the printing, thereby achieving multicolor two-side printing.

In another example of the on-press drawing lithographic printing apparatus, two plate cylinders are provided per one blanket cylinder and while performing the printing by one plate cylinder, the drawing can be performed on another plate cylinder. In this case, the driving of the plate cylinder under drawing is preferably made independent from the blanket by mechanical means. By constructing as such, the drawing can be performed without stopping the printing machine. Incidentally, as easily understood, this on-press drawing lithographic printing apparatus can be applied to the on-press drawing multicolor one-side lithographic printing apparatus or on-press drawing multicolor two-side lithographic printing apparatus.

The first and second embodiments of the present invention are described below.

The plate material (printing plate precursor) for use in the present invention is described below.

Examples of the printing plate precursor include metal plates such as steel plate subjected to plating with aluminum or chromium. An aluminum plate subjected to graining or anodization to impart good water retentivity and high abrasion resistance to the surface is particularly preferred. Also, a plate material obtained by providing an image-receiving layer on a paper imparted with water resistance or on a water-resistant support such as plastic film or plastic-laminated paper, may be used and this plate material is more inexpensive. The thickness of the plate material is suitably from 100 to 300 μm, in which the thickness of the image-receiving layer provided is suitably from 5 to 30 μm.

For the image-receiving layer, a hydrophilic layer comprising an inorganic pigment and a binder or a layer which can be rendered hydrophilic by a desensitization treatment may be used.

Examples of the inorganic pigment which can be used in the hydrophilic image-receiving layer include clay, silica, calcium carbonate, zinc oxide, aluminum oxide and barium sulfate. Examples of the binder which can be used include hydrophilic binders such as polyvinyl alcohol, starch, carboxymethyl cellulose, hydroxyethyl cellulose, casein, gelatin, polyacrylates, polyvinylpyrrolidone, and polymethyl ether-maleic anhydride copolymers. If desired, a melamine-formalin resin, a urea-formalin resin or other cross-linking agent may also be added so as to impart water resistance.

Examples of the image-receiving layer which is used after a desensitization treatment include a layer using zinc oxide and a hydrophobic binder.

The zinc oxide for use in the present invention may be any commercial product available as zinc oxide, zinc white, wet zinc white or activated zinc white, which are described, for example, in Shinpan Ganryo Binran (Handbook of Pigments, New Edition), compiled by Nippon Ganryo Gijutsu Kyokai, issued by Seibundo, page 319 (1968). That is, the zinc oxide includes those called a dry process such as French process (indirect process) and American process (direct process), and a wet process, according to the starting materials and the manufacturing method. Examples thereof include commercial products available from Seido Chemical Industry Co., Ltd., Sakai Chemical Industry Co., Ltd., Hakusui Chemical Industries, Ltd., The Honjo Chemical Corporation, Toho Zinc Co., Ltd., Mitsui Mining and Smelting Co., Ltd., and the like.

Specific examples of the resin used as a binder include styrene copolymers, methacrylate copolymers, acrylate copolymers, vinyl acetate copolymers, polyvinyl butyral, alkyd resins, epoxy resins, epoxy ester resins, polyester resins and polyurethane resins. These resins may be used individually or in combination of two or more thereof.

The content of the resin in the image-receiving layer is preferably, in terms of the weight ratio of resin/zinc oxide, from 9/91 to 20/80.

The desensitization of zinc oxide is performed by an ordinary method using a desensitizing solution and examples of conventionally known desensitizing solutions include a treating solution mainly comprising a ferrocyanate or a ferricyanate, a treating solution mainly comprising an ammine cobalt complex, a phytic acid or a derivative thereof, or a guanidine derivative, a treating solution mainly comprising an inorganic or organic acid capable of forming a chelate with zinc ion, and a treating solution containing a water-soluble polymer.

Examples of the ferrocyanate-containing treating solution include those described in JP-B-44-9045 (the term “JP-B” as used herein means an “examined Japanese patent publication”), JP-B-46-39403, JP-A-52-76101, JP-A-57-107889 and JP-A-54-117201.

The surface opposite the image-receiving layer of the plate material preferably has a Bekk smoothness of 150 to 700 (sec/10 ml). With this smoothness, the produced printing plate can be free of occurrence of slipping or sliding on the plate cylinder during the printing and good printing can be performed.

The Bekk smoothness as used herein can be measured by a Bekk smoothness tester. The Bekk smoothness tester is a tester where a test piece is pressed on a circular glass plate finished to a high smoothness and having a hole in the center under a constant pressure (1 kgf/cm² (9.8 N/cm²)) and the time necessary for a constant amount (10 ml) of air to pass through between the glass surface and the test piece under reduced pressure is measured.

The oil ink for use in the present invention is described below.

The oil ink for use in the present invention is obtained by dispersing resin particles which are solid and hydrophobic at least at an ordinary temperature, in a nonaqueous solvent having an electric resistivity of 10⁹ Ωcm or more and a dielectric constant of 3.5 or less.

The nonaqueous solvent having an electric resistivity 10⁹ Ωcm or more and a dielectric constant of 3.5 or less for use in the present invention is preferably a linear or branched aliphatic hydrocarbon, an alicyclic hydrocarbon, an aromatic hydrocarbon or a halogen substitution product of these hydrocarbons. Examples thereof include hexane, heptane, octane, isooctane, decane, isodecane, decalin, nonane, dodecane, isododecane, cyclohexane, cyclooctane, cyclodecane, benzene, toluene, xylene, mesitylene, Isoper C, Isoper E, Isoper G, Isoper H, Isoper L (Isoper: a trade name of Exxon Corp.), Shellsol 70, Shellsol 71 (Shellsol: a trade name of Shell Oil Corp.), Amsco OMS solvent, Amsco 460 solvent (Amsco: a trade name of American Mineral Spirits Co.), and silicone oil. These are used individually or in combination. The upper limit of the electric resistivity of the nonaqueous solvent is about 10¹⁶ Ωcm and the lower limit of the dielectric constant is about 1.9. The nonaqueous solvent is used also as a cleaning solution by itself or in combination with other solvent.

The electric resistance of the nonaqueous solvent used is specified to the above-described range because if the electric resistance is less than this range, resin particles or the like are not easily concentrated and a sufficiently long press life cannot be obtained. The dielectric constant is specified to the above-described range because if the dielectric constant exceeds this range, the electric field is relaxed due to polarization of the solvent and thereby, the ink is poorly ejected.

The resin particle dispersed in the nonaqueous solvent may be sufficient if it is a hydrophobic resin particle which is solid at a temperature of 35° C. or less and has high affinity for the nonaqueous solvent. However, the resin particle is preferably a resin (P) having a glass transition point of −5 to 110° C. or a softening point of 33 to 140° C., more preferably having a glass transition point of 10 to 100° C. or a softening point of 38 to 120° C., still more preferably having a glass transition point of 15 to 80° C. or a softening point of 38 to 100° C.

By using a resin having such a glass transition point or a softening point, the affinity between the surface of the image-receiving layer of the printing plate precursor and the resin particle increases and the bonding among resin particles is intensified on the printing plate precursor, so that the adhesion between the image area and the image-receiving layer is enhanced and the press life is also improved. If the glass transition point or softening point is lower or higher than the above-described range, the affinity between the surface of the image-receiving layer and the resin particle or the bonding force among resin particles may decrease.

The weight average molecular weight (Mw) of the resin (P) is from 1×10³ to 1×10⁶, preferably from 5×10³ to 8×10⁵, more preferably from 1×10⁴ to 5×10⁵.

Specific examples of the resin (P) include olefin polymers and copolymers (for example, polyethylene, polypropylene, polyisobutylene, ethylene-vinyl acetate copolymer, ethylene-acrylate copolymer, ethylene-methacrylate copolymer and ethylene-methacrylic acid copolymer), vinyl chloride polymers and copolymers (for example, polyvinyl chloride and vinyl chloride-vinyl acetate copolymer), vinylidene chloride copolymers, vinyl alkanoate polymers and copolymers, allyl alkanoate polymers and copolymers, polymers and copolymers of styrene and derivatives thereof (for example, butadiene-styrene copolymer, isoprene-styrene copolymer, styrene-methacrylate copolymer and styrene-acrylate copolymer), acrylonitrile copolymers, methacrylonitrile copolymers, alkyl vinyl ether copolymers, acrylic acid ester polymers and copolymers, methacrylic acid ester polymers and copolymers, itaconic acid diester polymers and copolymers, maleic acid anhydride copolymers, acrylamide copolymers, methacrylamide copolymers, phenolic resins, alkyd resins, polycarbonate resins, ketone resins, polyester resins, silicon resins, amide resins, hydroxyl group- or carboxyl group-modified polyester resins, butyral resins, polyvinyl acetal resins, urethane resins, rosin-type resins, hydrogenated rosin resins, petroleum resins, hydrogenated petroleum resins, maleic acid resins, terpene resins, hydrogenated terpene resins, chroman-indene resins, cyclic rubber-methacrylic acid ester copolymers, cyclic rubber-acrylic acid ester copolymers, copolymers containing a heterocyclic ring having no nitrogen atom (examples of the heterocyclic ring include a furan ring, a tetrahydrofuran ring, a thiophene ring, a dioxane ring, a dioxofuran ring, a lactone ring, a benzofuran ring, a benzothiophene ring and a 1,3-dioxetane ring), and epoxy resins.

The content of resin particles dispersed in the oil ink for use in the present invention is preferably from 0.5 to 20 wt % based on the entire ink. If the content is less than this range, problems are liable to arise, for example, the ink can hardly have affinity for the surface of the printing plate precursor to fail in obtaining a good image or the press life is shortened. On the other hand, if the content exceeds the above-described range, a uniform dispersion may not be easily obtained or non-uniform ink flow readily occurs in the ejection head to fail in attaining stable ink ejection.

The oil ink for use in the present invention preferably contains, together with the dispersed resin particles, a coloring material as a coloration component so as to facilitate inspection of the printing plate after the plate-making.

The coloring material may be any coloring material insofar as it is a pigment or a dye conventionally used in oil ink compositions or liquid developers for electrostatic photography.

For the pigment, a pigment commonly used in the field of printing may be used irrespective of an inorganic pigment or an organic pigment. Specific examples thereof include known pigments such as carbon black, cadmium red, molybdenum red, chrome yellow, cadmium yellow, titanium yellow, chromium oxide, viridian, cobalt green, ultramarine blue, Prussian blue, cobalt blue, azo-type pigments, phthalocyanine-type pigments, quinacridone-type pigments, isoindolinone-type pigments, dioxazine-type pigments, threne-type pigments, perylene-type pigments, perinone-type pigments, thioindigo-type pigments, quinophthalone-type pigments and metal complex pigments. These can be used without any particular limitation.

The dye is preferably an oil-soluble dye such as azo dye, metal complex salt dye, naphthol dye, anthraquinone dye, indigo dye, carbonium dye, quinoneimine dye, xanthene dye, aniline dye, quinoline dye, nitro dye, nitroso dye, benzoquinone dye, naphthoquinone dye, phthalocyanine dye and metallo-phthalocyanine dye.

These pigments and dyes may be used individually or in an appropriate combination, however, the content thereof is preferably from 0.01 to 5% by weight based on the entire ink.

The coloring material may be dispersed by itself as dispersed particles in the nonaqueous solvent separately from the dispersed resin particles or may be incorporated into the dispersed resin particles. In the latter case, a pigment is generally incorporated by a method of covering the pigment with the resin material of the dispersed resin particle to form a resin-covered particle, and a dye is generally incorporated by a method of coloring the surface part of the dispersed resin particle to form a colored particle.

In the present invention, the particles dispersed in the nonaqueous solvent, including the resin particles and further the colored particles, preferably have an average particle size of 0.05 to 5 μm, more preferably from 0.1 to 1.0 μm. This particle size is determined by CAPA-500 (trade name, manufactured by Horiba Seisakusho Co., Ltd.).

The nonaqueous dispersed resin particle for use in the present invention may be produced by a conventionally known mechanical grinding method or a polymerization granulating method. Examples of the mechanical grinding method include a method where materials for forming resin particles are mixed, if desired, and through melting and kneading, directly ground into fine particles by a known grinder and the fine particles are dispersed using a dispersion polymer in combination by a wet dispersing machine (for example, ball mill, paint shaker, Kedy mill or Dyno mill), and a method where component materials for forming resin particles and a dispersion aid polymer (or covering polymer) are previously kneaded and the kneaded product is ground and then dispersed in the presence of a dispersion polymer. Specifically, a production process of coating materials or liquid developers for electrostatic photography may be utilized and this is described, for example, in Kenji Ueki (supervisor of translation), Toryo no Ryudo to Ganryo Bunsan (Flow of Coating Materials and Dispersion of Pigments), Kyoritsu Shuppan (1971), Solomon, Toryo no Kagaku (Science of Coatings), Hirokawa Shoten (1969), Yuji Harasaki, Coating Kogaku (Coating Engineering), Asakura Shoten (1971), and Yuji Harasaki, Coating no Kiso Kagaku (Basic Science of Coating), Maki Shoten (1977).

Examples of the polymerization granulating method include a conventionally known nonaqueous dispersion polymerization method and this is specifically described in publications such as Soichi Muroi (supervisor of compilation), Cho-Biryushi Polymer no Saishin Gijutsu (Latest Technology of Ultrafine Polymers), Chapter 2, CMC Shuppan (1991), Koichi Nakamura, Saikin no Denshi-Shasin Genzo System to Toner Zairyo no Kaihatsu/Jitsuyoka (Recent Electrophotographic Developing Systems and Development and Practical Use of Toner Materials), Chapter 3, Nippon Kagaku Joho Co., Ltd. (1985), and K. E. J. Barrett, Dispersion Polymerization in Organic Media, John Wiley (1975).

In order to dispersion-stabilizing the disperse particles in a nonaqueous solvent, a dispersion polymer is usually used in combination. The dispersion polymer mainly comprises a repeating unit soluble in a nonaqueous solvent and preferably has an average molecular weight, in terms of a weight average molecular weight (Mw), of 1×10³ to 1×10⁶, more preferably from 5×10³ to 5×10⁵.

The preferred soluble repeating unit of the dispersion polymer for use in the present invention includes a polymerization component represented by the following formula (I):

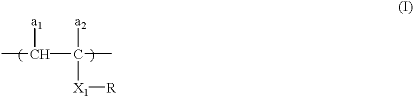

In formula (I), X₁ represents —COO—, —OCO— or —O—, R represents an alkyl or alkenyl group having from 10 to 32 carbon atoms, preferably an alkyl or alkenyl group having from 10 to 22 carbon atoms, which may be linear or branched and may have a substituent but is preferably unsubstituted.

Specific examples thereof include a decyl group, a dodecyl group, a tridecyl group, a tetradecyl group, a hexadecyl group, an octadecyl group, an eicosanyl group, a docosanyl group, a decenyl group, a dodecenyl group, a tridecenyl group, a hexadecenyl group, an octadecenyl group and a linolenyl group.

a₁ and a₂, which may be the same or different, each represents a hydrogen atom, a halogen atom (e.g., chlorine, bromine), a cyano group, an alkyl group having from 1 to 3 carbon atoms (e.g., methyl, ethyl, propyl), —COO—Z₁ or —CH₂COO—Z₁ (wherein Z₁ represents a hydrocarbon group having 22 or less carbon atoms, which may be substituted, such as alkyl group, alkenyl group, aralkyl group, alicyclic group and aryl group).

Among the hydrocarbon groups represented by Z₁, preferred hydrocarbon groups are an alkyl group having from 1 to 22 carbon atoms, which may be substituted, such as methyl group, ethyl group, propyl group, butyl group, hexyl group, heptyl group, octyl group, nonyl group, decyl group, dodecyl group, tridecyl group, tetradecyl group, hexadecyl group, octadecyl group, eicosanyl group, docosanyl group, 2-chloroethyl group, 2-bromoethyl group, 2-cyanoethyl group, 2-methoxycarbonylethyl group, 2-methoxyethyl group and 3 -bromopropyl group; an alkenyl group having from 4 to 18 carbon atoms, which may be substituted, such as 2-methyl-1-propenyl group, 2-butenyl group, 2-pentenyl group, 3 -methyl-2-pentenyl group, 1-pentenyl group, 1-hexenyl group, 2-hexenyl group, 4-methyl-2-hexenyl group, decenyl group, dodecenyl group, tridecenyl group, hexadecenyl group, octadecenyl group and linolenyl group; an aralkyl group having from 7 to 12 carbon atoms, which may be substituted, such as benzyl group, phenethyl group, 3-phenylpropyl group, naphthylmethyl group, 2-naphthylethyl group, chlorobenzyl group, bromobenzyl group, methylbenzyl group, ethylbenzyl group, methoxybenzyl group, dimethylbenzyl group and dimethoxybenzyl group; an alicyclic group having from 5 to 8 carbon atoms, which may be substituted, such as cyclohexyl group, 2-cyclohexylethyl group and 2 -cyclopentylethyl group; and an aromatic group having from 6 to 12 carbon atoms, which may be substituted, such as phenyl group, naphthyl group, tolyl group, xylyl group, propylphenyl group, butylphenyl group, octylphenyl group, dodecylphenyl group, methoxyphenyl group, ethoxyphenyl group, butoxyphenyl group, decyloxyphenyl group, chlorophenyl group, dichlorophenyl group, bromophenyl group, cyanophenyl group, acetylphenyl group, methoxycarbonyl-phenyl group, ethoxycarbonylphenyl group, butoxycarbonyl-phenyl group, acetamidophenyl group, propionamidophenyl group and dodecyloylamidophenyl group.

The dispersion polymer may contain another repeating unit as a copolymerization component together with the repeating unit represented by formula (I). The another copolymerization component may be any compound insofar as it comprises a monomer copolymerizable with the monomer corresponding to the repeating unit represented by formula (I).

The percentage of the polymer component represented by formula (I) occupying in the dispersion polymer is preferably 50% by weight or more, more preferably 60% by weight or more.

Specific examples of the dispersion polymer include those described in JP-A-10-204354, JP-A-10-204356, JP-A-10-259336, JP-A-10-306244, JP-A-10-316917 and JP-A-10-316920, and Resin (Q-1) for dispersion stabilization used in Examples. Also, commercially available products (for example, Solprene 1205, produced by Asahi Chemical Industry Co., Ltd.) may be used.

In the case of producing the particles of Resin (P) as a dispersion (latex) or the like, the dispersion polymer is preferably added in advance to the polymerization.

The amount of the dispersion polymer added is approximately from 1 to 50% by weight based on Resin (P) for particles.

The dispersed resin particle and colored particle (or coloring material particle) in the oil ink for use in the present invention each is preferably an electroscopic particle bearing positive or negative charge.

The electroscopicity can be imparted to these particles by appropriately using a technique of developers for wet electrostatic photography. To speak specifically, the electroscopicity is imparted using an electroscopic material such as charge controlling agent, and other additives described, for example, in Saikin no Denshi-Shasin Genzo System to Toner Zairyo no Kaihatsu/Jitsuyoka (Recent Electrophotographic Developing Systems and Development and Practical Use of Toner Materials), supra, pp. 139-148, Denshi Shashin Gijutsu no Kiso to Oyo (Elementary Study and Application of Electrophotographic Technology), Denshi Shashin Gakkai (compiler), pp. 497-505, Corona Sha (1988), and Yuji Harasaki, Denshi Shashin (Electrophotography), 16 (No. 2), page 44 (1977).

This is more specifically described, for example, in British Patents 893,429, 934,038 and 1,122,397, U.S. Pat. Nos. 3,900,412 and 4,606,989, JP-A-60-179751, JP-A-60-185963 and JP-A-2-13965.

The amount of such a charge controlling agent is preferably from 0.001 to 1.0 part by weight per 1,000 parts by weight of the dispersion medium as a carrier liquid. If desired, various additives may be further added and the upper limit of the total amount of these additives is determined by the electric resistance of the oil ink. More specifically, if the electric resistivity of the ink in the state where dispersed particles are removed is less than 10⁹ Ωcm, an image with good continuous gradation may not be obtained. Therefore, the amounts of the additives are preferably controlled within this limit.

The prevention of coagulation and/or precipitation of ink is described below.

If the liquid current of ink becomes stationary within the ink tank and the ink particles coagulate and/or precipitate, the pipe or head is clogged and the ink cannot be stably ejected. To overcome this problem, coagulation and/or precipitation of causing an aggregate or a precipitate are prevented to obtain uniform ink particles. The prevention of coagulation and/or precipitation can be attained by an operation containing at least one of stirring, dispersion, mixing and jetting. According to the volume and kind of the ink, these operations can be applied as a single operation, a plurality of operations or multiple operations. By disposing the coagulation and/or precipitation-preventing means upstream the ink ejection part, uniform ink particles can be fed to the ink ejection part but by taking account of dormant state or stationary liquid current, it is more effective to provide a pipeline stirrer such as pipeline mixer or inline mixer immediately before the ink ejection part. In the case where the ink is restarted flowing after dormancy, it is effective to actuate the coagulation and/or precipitation-preventing means before the ink is restarted flowing, so as not to feed an aggregate or a precipitate to the ejection part and to uniformalize the ink particles. Furthermore, when the coagulation and/or precipitation-preventing means is a cartridge type and exchangeably installed on the flow path of ink, coagulation and/or precipitation-preventing means different in the activity can be appropriately selected according to the volume or kind of ink and also, the maintenance property can be enhanced.

Specific examples of the coagulation and/or precipitation-preventing means include, as means having a stirring activity, a stirrer where the stirring blade has a disk-like or fan-like shape and the peripheral speed of the stirring blade is from 1 to 3,000 rpm, a homomixer which is constructed by a turbine having a high rotation speed and a special shape and a stator having a radial baffle and which stirs an aggregate and the like using the ejection of ink resulting from the pressure difference generated between the bottom and the top of the turbine upon high-speed rotation of the turbine, a pipeline mixer which stirs an aggregate and the like by the rotation of a stirring blade disposed in the flow path of ink, a magnet mixer (e.g., magnetic stirrer manufactured by Tokai Riki K.K., star head stirrer), a supervibration stirrer which stirs and disperses an aggregate and the like by ultrasonic vibration, and a LAMOND stirrer (manufactured by Tokai Riki K.K.) which has a structure such that two discs having disposed therein a honeycomb-type wall are superposed and which absorbs an ink from the axis center on the lower surface by the rotation of discs (stirring discs) and blowing out and thereby stirring the ink from the lateral surface over the honeycomb wall.

Examples of the means having a dispersing activity include a homogenizer which disperses an aggregate and the like by the rotation of a stirring blade (e.g., a homogenizer manufactured by Nippon Seiki Seisakusho K.K.), an ultrasonic homogenizer which disperses an aggregate and the like by ultrasonic vibration (e.g., an ultrasonic homogenizer manufactured by Nippon Seiki Seisakusho K.K.), an ultrasonic filter which disperses an aggregate by high-speed vibrating the filtering filter surface (e.g., an ultrasonic stirrer manufactured by Ginsen K.K.), a high-speed disperser (e.g., Kedy mill), an ultrasonic cleaner (e.g., an ultrasonic cleaner manufactured by Nippon Seiki Seisakusho K.K.) and a supervibration stirrer (e.g., supervibration α-stirrer manufactured by Nippon Techno K.K.).

Examples of the means having a mixing activity include a mixing pump which can attain uniform mixing by the two liquid mixing function (e.g., a mixing pump manufactured by Nippon Ball Valve K.K.), and an inline mixer which mixes an ink by a plurality of stirring blades fixed to a rotation axis in a vessel (e.g., Dynamic mixer manufactured by Nippon Ball Valve K.K.).

Examples of the means having a jetting activity include a (underwater) pump (e.g., a pump manufactured by Reisy K.K.)

In the present invention, these means are preferably used after arbitrarily downsized or partially modified.

### EXAMPLES

The present invention is described in greater detail below by referring to Examples, however, the present invention should not be construed as being limited thereto.

A production example of Resin Particle (PL) for ink is described below.

### Production Example 1 of Resin Particle (PL-1)

A mixed solution containing 10 g of Resin (Q-1) for dispersion stabilization having a structure shown below, 100 g of vinyl acetate and 384 g of Isoper H was heated to a temperature of 70° C. while stirring in a nitrogen stream. Thereto, 0.8 g of 2,2′-azobis(isovaleronitrile) (herein-after simply referred to as “A.I.V.N.”) was added as a polymerization initiator and reacted for 3 hours. 20 Minutes after the addition of the initiator, the solution turned to milky white and the reaction temperature was elevated to 88° C. Thereto, 0.5 g of the same initiator was further added and reacted for 2 hours. Thereafter, the temperature was elevated to 100° C., the reaction solution was stirred for 2 hours, and unreacted vinyl acetate was removed by distillation. The residue was cooled and passed through a 200-mesh nylon cloth. The obtained white dispersion was a latex having a polymerization percentage of 90%, an average particle size of 0.23 μm and good monodispersivity. The particle size was measured by CAPA-500 (manufactured by Horiba Seisakusho K.K.).

Resin (Q-1) for Dispersion Stabilization:

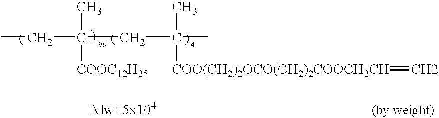

A part of this white dispersion was centrifuged (rotation number: 1×10⁴ rpm, rotation time: 60 minutes) and the precipitated resin particle portion was collected and dried. The resin particle portion had a weight average molecular weight (Mw, GPC value in terms of polystyrene) of 2×10⁵ and a glass transition point (Tg) of 38° C.

### Example 1

An oil ink was prepared.

<Preparation of Oil Ink (IK-1)>

Into a paint shaker (manufactured by Toyo Seiki K.K.), 10 g of a dodecyl methacrylate/acrylic acid copolymer (copolymerization ratio: 95/5 by weight), 10 g of nigrosine and 30 g of Shellsol 71 were charged together with glass beads and dispersed for 4 hours to obtain a fine nigrosine dispersion.

Then, 60 g (as solid contents) of Resin Particle (PL-1) produced in Preparation Example 1 of Resin Particle for Ink, 2.5 g of the nigrosine dispersion prepared above, 15 g of FOC-1400 (tetradecyl alcohol, produced by Nissan Chemical Industries Co., Ltd.) and 0.08 g of an octadecene-half maleic acid octadecylamide copolymer were diluted with 1 liter of Isoper G to prepare a black oil ink.

Thereafter, 2 liter of the thus-prepared Oil Ink (IK-1) was filled in an ink tank of an ink jet drawing device 2 of a plate-making apparatus (see, FIGS. 1, 3 and 4). The ejection head used here was a 900 dpi multi-channel head of 64 channels shown in FIG. 5 and for feeding the ink, a piezoelectric pump was used. In the ink tank 25, an immersion heater and a stirring blade 71 (LAMOND stirrer (Model ST02) manufactured by Tokai Riki K.K.) were provided as the ink temperature-controlling means and by setting the ink temperature to 30° C., the temperature was controlled using a thermostat while rotating the stirring blade 71 at 30 rpm. The stirring blade 71 used here was also served as the coagulation and/or precipitation-preventing means for preventing precipitation/coagulation by driving it with a stirring motor 70 (a simple stirrer (Model K-1R) manufactured by Tokai Riki K.K.). A part of the ink flow path was made transparent, and an LED light-emitting device and a light-detecting device were disposed to sandwich the transparent portion. Based on the output signal therefrom, the concentration was controlled by charging a diluting solution (Isoper G) for ink or a concentrated ink (Ink (IK-1) adjusted to a 2-fold solid concentration).

A 0.12 mm-thick aluminum plate subjected to graining and anodization was used as the plate material and mounted by a mechanical device provided on the drum of a plate-making apparatus while gripping the head and edge of the plate. After removing dusts on the surface of the plate material by air pump suction, the ejection head was approximated to the plate material until the drawing position. Then, the image data to be drawn on the plate were transmitted to the image data arithmetic and control part and the 64-channel ejection head was moved while rotating the drum, thereby ejecting an oil ink onto the aluminum plate to form an image. At this time, the tip width of the ejection electrode of the ink jet head was 10 μm and the distance between the head and the plate material was controlled to 1 mm according to the output from an optical gap detecting device. A voltage of 2.5 KV was always applied as a bias voltage and at the time of performing the ejection, a pulse voltage of 500 V was superimposed. The pulse voltage was changed through 256 stages in the range from 0.2 to 0.05 msec so as to perform the drawing while changing the dot area. As a result, good plate-making was attained, where drawing failure due to ink aggregate or dust was not observed at all and the image was completely free of deterioration due to change in the dot size or the like even when the ambient temperature was changed or the number of processed plates increased.

The image was further firmly fixed by the heating using a xenon flash fixing device (manufactured by Ushio Denki, emission intensity: 200 J/pulse), thereby manufacturing a printing plate. The ink jet drawing device with the sub-scanning means was retreated 50 mm from the position proximate to the drum so as to protect the ink jet head. Thereafter, the printing plate was taken out from the plate-making apparatus and attached to the plate cylinder of a press Oliver 266 EPZ and then, printing was performed.

The printed matters obtained had a very clear image free of slipping or thinning of the printing image even after 10,000 sheets were continuously printed.

After the completion of plate-making, Isoper G was fed to the head for 10 minutes to drop Isoper G from the head opening and thereby clean the head and then, the head was housed in a cover filled with a vapor of Isoper G, as a result, a printing plate capable of giving good printed matters without requiring any maintenance operation for 3 months could be obtained.

### Example 2

In an apparatus shown in FIG. 12 where the coagulation and/or precipitation-preventing means (stirring motor 70 and stirring blade 71) of the ink jet drawing device shown in FIG. 4 was changed to an underwater pump 72, a 600 dpi full line ink jet head of the type shown in FIG. 6 was disposed. For the circulation of ink, Micro-Gear Pump (manufactured by Chuo Rika Kogyo K.K.) was used. An ink reservoir was provided between this pump and the ink inflow path of the ejection head and between the ink recovery path of the ejection head and the ink tank. The ink was circulated using the difference in the hydrostatic pressure therebetween. A heater and the above-described pump were used as the ink temperature-controlling means and the ink temperature set to 35° C. was controlled by a thermostat. The underwater pump (Reisy Pump (Model P-112) manufactured by Reisy K.K.) shown by 72 in the Figure, which was used as the circulation pump, was served also as the coagulation and/or precipitation-preventing means for preventing precipitation and coagulation. An electrical conductivity-measuring device was disposed on the ink flow path and based on the output signal therefrom, the concentration was controlled by diluting the ink or charging a concentrated ink. The aluminum plate prepared above was similarly fixed as the plate material to the drum of the plate-making apparatus. After removing dusts on the surface of the plate material using a nylon-made rotary brush, the image data to be drawn on the plate was transmitted to the image data arithmetic and control part and while transporting the plate material by capstan rollers, the full line head was allowed to perform the drawing by ejecting an oil ink onto the aluminum plate to form an image. As a result, good plate-making could be attained, where drawing failure and the like due to aggregates of ink was not observed at all and even when the ambient temperature was changed or the number of processed plates increased, the image was completely free from deterioration due to change in the dot size and the like. The image was strengthened under heating (pressure: 3 kgf/cm² (29.4 N/cm²)) by the heat roller (a 300-W halogen lamp in which Teflon seal silicon rubber roller is self-contained) fixing, thereby preparing a printing plate.

Using the manufactured plate, printing was performed in the same manner as in Example 1, as a result, a very clear image free of slipping or thinning of the printing image could be obtained even after 10,000 sheets were continuously printed. After the completion of plate-making, Isoper G was circulated to the head and then a non-woven fabric impregnated with Isoper G was contacted with the head tip to perform the cleaning, as a result, a printing plate capable of giving good printed matters without requiring any maintenance operation for 6 months could be manufactured.

The drawing and printing were performed in the same manner except for using a 600 dpi full line ink jet head of the type shown in FIG. 8 and FIG. 10 in place of the ink jet head of the type shown in FIG. 6, as a result, good results were obtained similarly to the above.

By virtue of use of the stirring means, a high-quality image could be always stably drawn in any case.

### Example 3

The same operation as in Example 1 was performed except that a plate material having provided on the surface thereof an image-receiving layer capable of hydrophilizing by a desensitization treatment, which is described below, was used in place of the aluminum plate of Example 1, the non-image area after the preparation of the printing plate was hydrophilized using a plate surface-desensitizing device, the electrically conducting layer of the plate material was earthed by the contact with an electrically conducting plate spring (made of phosphor bronze) at the time of drawing, and the fixing was performed by blowing hot air to the plate material.

A wood-free paper having a basis weight of 100 g/m² was used as the substrate. On both surfaces of the substrate, a polyethylene film was laminated to a thickness of 20 μm to render the surfaces water-resistant and on one surface of this paper support, a coating material for the electrically conducting layer prepared as follows to have a composition shown below was coated to a dry coated amount of 10 g/m². Thereon, Dispersion Solution A was further coated to a dry coated weight of 15 g/m², thereby providing an image-receiving layer. Thus, the plate material was prepared.

Coating Material for Electrically Conducting Layer:

5.4 Parts of carbon black (30% water dispersion), 54.6 parts of clay (50% water dispersion), 36 parts of SBR latex (solid content: 50%, Tg: 25° C.) and 4 parts of melamine resin (Sumirez Resin SR-613, solid content: 80%) were mixed and water was added to make a total solid content of 25%, thereby preparing the coating material.

Dispersion Solution A:

A mixture containing 100 g of dry zinc oxide, 3 g of Binder Resin (B-1) having a structure shown below, 17 g of Binder Resin (B-2) having a structure shown below, 0.15 g of benzoic acid and 155 g of toluene was dispersed using a wet dispersing homogenizer (manufactured by Nippon Seiki K.K.) at a rotation number of 6,000 rpm for 8 minutes.

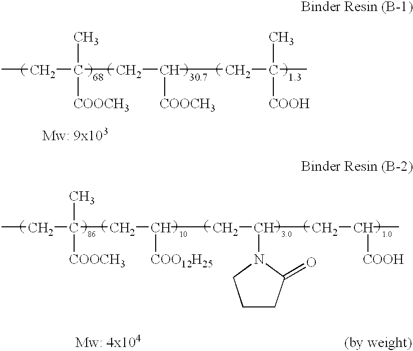

At the time of performing the fixing by blowing hot air to the plate material, blister was generated. Accordingly, the fixing was performed by gradually and continuously elevating the supply power to the heater used for blowing hot hair or by gradually and continuously reducing the rotation speed of the drum from high to low while not changing the supply power. As a result, blister was not generated and the printed matter obtained by the printing using the thus-obtained printing plate had a very clear image free of slipping or thinning of the printing image even after 5,000 sheets were continuously printed.

### Example 4

In place of the stirring blade 71 of Example 1, the coagulation and/or precipitation-preventing means shown in FIG. 13 was used. More specifically, a magnetic spin bar 81 (Star Head Magnetic Spin Bar (size 58) manufactured by Tokai Riki K.K.) was placed in the ink tank 25 and the ink was stirred by a stirrer 82 (magnetic stirrer (Model HS-50E) manufactured by Tokai Riki K.K.) provided outside the ink tank 25.

### Example 5

In place of the stirring blade 71 of Example 1, the coagulation and/or precipitation-preventing means shown in FIG. 14 was used. More specifically, an ultrasonic bath 83 (ultrasonic cleaning vessel (Model USK-2) manufactured by Tokai Riki K.K.) was used as the ink tank 25 and the ink was dispersed by ultrasonic vibration.

### Example 6

In place of the stirring blade 71 of Example 1, the coagulation and/or precipitation-preventing means shown in FIG. 15 was used. More specifically, a piezoelectric transducer 84 (φ5) was placed in the ink tank 25 and the ink was dispersed by vibrating the piezoelectric transducer 84 using an oscillator 85 (ultrasonic disperser (Model UH-50) manufactured by Tokai Riki K.K.).

### Example 7

In place of the stirring blade 71 of Example 1, the coagulation and/or precipitation-preventing means shown in FIG. 16 was used. More specifically, a multistage vibrating blade (single axis type) was placed in the ink tank 25 and the ink was stirred with low frequency vibration by transmitting a low frequency from a vibrator 87 (supervibration α-stirrer manufactured by Nippon Techno K.K.) to the vibration blade 86. The stirring of Example 7 is not performed by the rotation of stirring blade as in Example 1 but performed using vibration of the stirring blade and therefore, air is not mingled into the ink. Furthermore, since the blade is not rotated, the blade can be provided in the most lateral end of the ink tank and the latitude of installation is broad.

In Examples 1 to 7, when the drawing was performed using no stirring/dispersing means, the ejection became unstable in a few hours to a few days in any Example and after disorder of image or non-ejection state continued, the ejection port of the head was at the worst completely clogged with coarse semi-solid aggregates of ink particles and the drawing could not be performed.

The coagulation and/or precipitation-preventing means for preventing coagulation/precipitation shown in Examples above, some of which are large-size equipment for the production line, are preferably downsized to an appropriate size according to the size of the ink tank and the required capacity and modified to enable the application to the plate-making apparatus of the present invention.

According to the present invention, a printing plate capable of printing a large number of printed matters having a clear image can be manufactured. Furthermore, a printing plate having a high-quality image directly responded to the digital image data can be stably manufactured and therefore, the lithographic printing can be performed at a low cost and at a high speed. In addition, by providing ink stirring means, a printing plate having a high-quality image can be manufactured.

### Example 2-1

An oil ink was prepared.

<Preparation of Oil Ink (IK-1)>

Into a paint shaker (manufactured by Toyo Seiki K.K.), 10 g of a dodecyl methacrylate/acrylic acid copolymer (copolymerization ratio: 95/5 by weight), 10 g of nigrosine and 30 g of Shellsol 71 were charged together with glass beads and dispersed for 4 hours to obtain a fine nigrosine dispersion.

Then, 60 g (as solid contents) of Resin Particle (PL-1) produced in Preparation Example 1 of Resin Particle for Ink, 2.5 g of the nigrosine dispersion prepared above, 15 g of FOC-1400 (tetradecyl alcohol, produced by Nissan Chemical Industries Co., Ltd.) and 0.08 g of an octadecene-half maleic acid octadecylamide copolymer were diluted with 1 liter of Isoper G to prepare a black oil ink.

Thereafter, 2 liter of the thus-prepared Oil Ink (IK-1) was filled in an ink tank of an ink jet recording device of an on-press drawing lithographic printing apparatus (see, FIGS. 2-1 and 2-2). The recording head used here was a 900 dpi multi-channel head of 64 channels shown in FIG. 2-3 and for feeding the ink, a piezoelectric pump was used. In the ink tank 2-25, an immersion heater and a stirring blade 2-71 (LAMOND stirrer (Model ST02) manufactured by Tokai Riki K.K.) were provided as the ink temperature-controlling means and by setting the ink temperature to 30° C., the temperature was controlled using a thermostat while rotating the stirring blade 2-71 at 30 rpm. The stirring blade 2-71 used here was also served as the coagulation and/or precipitation-preventing means for preventing precipitation/coagulation by driving it with a stirring motor 2-70 (a simple stirrer (Model K-1R) manufactured by Tokai Riki K.K.). A part of the ink flow path was made transparent, and an LED light-emitting device and a light-detecting device were disposed to sandwich the transparent portion. Based on the output signal therefrom, the concentration was controlled by charging a diluting solution (Isoper G) for ink or a concentrated ink (Ink (IK-1) adjusted to a 2-fold solid concentration).

A 0.12 mm-thick aluminum plate subjected to graining and anodization was used as the plate material and mounted by a mechanical device provided on the plate cylinder while gripping the head and edge of the plate. After keeping apart the fountain solution feed device, the printing ink feed device and the blanket cylinder not to come into contact with the plate material and further removing dusts on the surface of the plate material by air pump suction, the recording head was approximated to the plate material until the drawing position. Then, the image data to be printed were transmitted to the image data arithmetic and control part and the 64-channel recording head was moved while rotating the plate cylinder, thereby ejecting an oil ink onto the aluminum plate to form an image. At this time, the tip width of the ejection electrode of the ink jet head was 10 μm and the distance between the head and the plate material was controlled to 1 mm according to the output from an optical gap detecting device. A voltage of 2.5 KV was always applied as a bias voltage and at the time of performing the ejection, a pulse voltage of 500 V was superimposed. The pulse voltage was changed through 256 stages in the range from 0.2 to 0.05 msec so as to perform the drawing while changing the dot area. As a result, good plate-making was attained, where drawing failure due to ink aggregate, mingled foreign matters such as solid dust, or powder dust was not observed at all and the image was completely free of deterioration due to change in the dot size or the like even when the ambient temperature was changed or the number of processed plates increased.

The image was further firmly fixed by the heating using a xenon flash fixing device (manufactured by Ushio Denki, emission intensity: 200 J/pulse), thereby manufacturing a printing plate. The ink jet recording device with the sub-scanning means was retreated 50 mm from the position proximate to the plate cylinder so as to protect the ink jet head. Thereafter, printing was performed on a coated paper for printing in the same manner as above by a normal lithographic printing method. That is, a printing ink and a fountain solution were given to form a printing image, this printing ink image was transferred onto a blanket cylinder rotating together with the plate cylinder and the printing ink image on the blanket cylinder was transferred to the coated paper for printing passing between the blanket cylinder and the impression cylinder.

The printed matters obtained had a very clear image free of slipping or thinning of the printing image even after 10,000 sheets were continuously printed.

10 Minutes after the completion of plate-making, Isoper G was fed to the head and the head was cleaned by dripping Isoper G from the head opening and then housed in a cover filled with a vapor of Isoper G, as a result, good printed matters could be obtained without requiring any maintenance operation for 3 months.

CTC

### Example 2-2

In an apparatus shown in FIG. 2-12 where the coagulation and/or precipitation-preventing means (stirring motor 2-70 and stirring blade 2-71) of the ink jet drawing device 2-24 shown in FIG. 2-11 was changed to an underwater pump 2-72, a 600 dpi full line ink jet head of the type shown in FIG. 2-4 was disposed. For the circulation of ink, Micro-Gear Pump (manufactured by Chuo Rika Kogyo K.K.) was used. An ink reservoir was provided between this pump and the ink inflow path of the ejection head and between the ink recovery path of the ejection head and the ink tank. The ink was circulated using the difference in the hydrostatic pressure therebetween. A heater and the above-described pump were used as the ink temperature-controlling means and the ink temperature set to 35° C. was controlled by a thermostat. The underwater pump (Reisy Pump (Model P-112) manufactured by Reisy K.K.) shown by 2-72 in the Figure, which was used as the circulation pump, was served also as the coagulation and/or precipitation-preventing means for preventing precipitation and coagulation. An electrical conductivity-measuring device was disposed on the ink flow path and based on the output signal therefrom, the concentration was controlled by diluting the ink or charging a concentrated ink.

The aluminum plate described above was attached as the plate material in the same manner to the plate cylinder of the lithographic printing apparatus. After removing dusts on the surface of the plate material using a nylon-made rotary brush, the image data to be printed was transmitted to the image data arithmetic and control part and while rotating the plate cylinder, the full line head was allowed to perform the drawing by ejecting an oil ink onto the aluminum plate to form an image. As a result, good plate-making could be attained, where drawing failure and the like ascribable to ink aggregates, mingled foreign matters such as solid dust, or powder dust were not observed at all and even when the ambient temperature was changed or the number of processed plates increased, the image was completely free from deterioration due to change in the dot size and the like. Subsequently, the image was firmly fixed by a heat roll fixing device (produced by Hitachi Kinzoku K.K., powder: 1.2 kW). This was used as the printing plate.

Using the plate manufactured, printing was performed, as a result, a very clear image free of slipping or thinning of the printing image could be obtained even after 10,000 sheets were continuously printed. After the completion of plate-making, Isoper G was circulated to the head and then a non-woven fabric impregnated with Isoper G was contacted with the head tip to perform the cleaning, as a result, good printed matters could be obtained without requiring any maintenance operation for 3 months.

Furthermore, the drawing and printing were performed in the same manner except for using a 600 dpi full line ink jet head of the type shown in FIG. 2-7 and FIG. 2-9 in place of the ink jet head of the type shown in FIG. 2-4, as a result, good results were obtained similarly to the above.

By virtue of use of the stirring means, a high-quality image could be always stably drawn in any case.

### Example 2-3

A full line head shown in FIG. 2-7 was used as the recording head for the ink jet recording device of an on-press drawing four-color one-side lithographic printing apparatus (see, FIG. 2-10) and the gap was adjusted (gap: 0.8 mm) by a Teflon-made knock roller. Thereafter, 5,000 plates were manufactured by performing the same operation as in Example 1 except for supplying a concentrated ink to the ink tank according to the number of drawn plates as the ink concentration-controlling means. As a result, drawing failure due to ink aggregate, mingled foreign matter such as solid dust, or powder dust was not observed at all and also, the effect by the change in the outside temperature was not observed at all. The dot size was slightly changed by the increase of the plates manufactured but this was in the negligible level. The manufactured plate was subjected to flash fixing in the same manner as above and further to fixing by the irradiation of a halogen lamp (QIR manufactured by Ushio Denki K.K., power demanded: 1.5 kW) and by the spraying of ethyl acetate.

The halogen lamp was irradiated to perform the heating at a plate surface temperature of 95° C. for 20 seconds. The ethyl acetate was sprayed to a spray amount of about 1 g/m². As a result, even after 10,000 sheets were continuously printed, a very clear full color printed matter free of slipping or thinning of the printing image could be obtained. Particularly, in the fixing using a heat roll or a halogen lamp, the fixing time could be greatly shortened by wrapping a heat insulating material (PET film) around the plate cylinder. In this case, the aluminum substrate was earthed by the contact with an electrically conducting brush (SANDERON, manufactured by Tsuchiya, resistance: about 10 to 1 Ω cm).

CTC

### Example 2-4

In place of the stirring blade 2-71 of Example 2-1, the coagulation and/or precipitation-preventing means shown in FIG. 2-13 was used. More specifically, a magnetic spin bar 2-81 (Star Head Magnetic Spin Bar (size 58) manufactured by Tokai Riki K.K.) was placed in the ink tank 2-25 and the ink was stirred by a stirrer 2-82 (magnetic stirrer (Model HS-50E) manufactured by Tokai Riki K.K.) provided outside the ink tank 2-25.

The same operation as in Example 2-1 was performed except that a paper plate material having provided on the surface thereof a hydrophilic image-receiving layer shown below was used in place of the aluminum plate of Example 2-1.

A wood-free paper having a basis weight of 100 g/m² was used as the substrate. On both surfaces of the substrate, a water-resistant layer mainly comprising kaolin and resin components of polyvinyl alcohol, SBR latex and melamine resin was provided and on the thus-obtained paper support, Dispersion Solution A prepared as follows to have a composition shown below was coated to a dry coated amount of 6 g/m², thereby providing an image-receiving layer. This was used as the paper plate material.

Dispersion Solution A:

| | | |
|---|---|---|
| Gelatin (extra pure product, produced by | 3 | g |
| Wako Pure Chemical Industries, Ltd.) | | |
| Colloidal silica (Snowtex C, produced by | 20 | g |
| Nissan Chemical, 20% water dispersion) | | |
| Silica gel (Cylisia #310, produced by Fuji | 7 | g |
| Cylisia Kagaku) | | |
| Curing agent | 0.4 | g |
| Distilled water | 100 | g |

These were dispersed together with glass beads in a paint shaker for 10 minutes.

The obtained printed matter had a very clear image free of slipping or thinning of the printing image even after 10,000 sheets were continuously printed.

On the other hand, when wood-free paper was used as the printing paper sheet, the solid making was partially failed due to paper dust after 3,000 sheets were printed. Therefore, an air suction pump was disposed as a paper dust-preventing device in the vicinity of the paper feed part and then, printing was performed.

As a result, printing failure was not generated and the printed matters obtained had a very clear image free of slipping or thinning even after 5,000 sheets were continuously printed. However, after printing of 5,000 sheets, the image of A3 size was elongated by 0.1 mm in the machine direction.

### Example 2-5

In place of the stirring blade 2-71 of Example 2-1, the coagulation and/or precipitation-preventing means shown in FIG. 2-14 was used. More specifically, an ultrasonic bath 2-83 (ultrasonic cleaning vessel (Model USK-2) manufactured by Tokai Riki K.K.) was used as the ink tank 2-25 and the ink was dispersed by ultrasonic vibration. Furthermore, a plate material having provided on the surface thereof an image-receiving layer capable of hydrophilizing by a desensitization treatment, shown below, was used in place of the aluminum plate of Example 2-1, the non-image area after the preparation of the printing plate was hydrophilized using a plate surface-desensitizing device, the electrically conducting layer of the plate material was earthed by the contact with an electrically conducting plate spring (made of phosphor bronze) at the time of drawing, and the fixing was performed by blowing hot air to the plate material. Other than these, the same operation as in Example 2-1 was performed.

A wood-free paper having a basis weight of 100 g/m² was used as the substrate. On both surfaces of the substrate, a polyethylene film was laminated to a thickness of 20 μm to render the surfaces water-resistant and on one surface of this paper support, a coating material for the electrically conducting layer prepared as follows to have a composition shown below was coated to have a dry coated amount of 10 g/m². Thereon, Dispersion Solution B was further coated to have a dry coated weight of 15 g/m², thereby providing an image-receiving layer. This was used as the plate material.

Coating Material for Electrically Conducting Layer:

5.4 Parts of carbon black (30% water dispersion), 54.6 parts of clay (50% water dispersion), 36 parts of SBR latex (solid content: 50%, Tg: 25° C.) and 4 parts of melamine resin (Sumirez Resin SR-613, solid content: 80%) were mixed and water was added to make a total solid content of 25%, thereby preparing the coating material.

Dispersion Solution B:

A mixture containing 100 g of dry zinc oxide, 3 g of Binder Resin (B-1) having a structure shown below, 17 g of Binder Resin (B-2) having a structure shown below, 0.15 g of benzoic acid and 155 g of toluene was dispersed using a wet dispersing Homogenizer (manufactured by Nippon Seiki K.K.) at a rotation number of 6,000 rpm for 8 minutes.

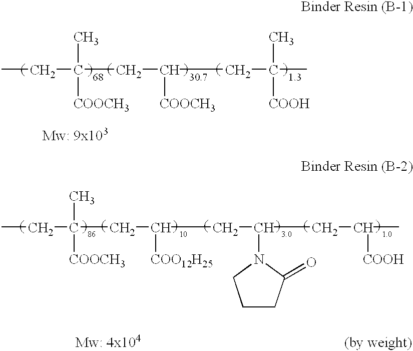

The printed matters obtained had a very clear image free of slipping or thinning of the printing image even after 5,000 sheets were continuously printed.

### Example 2-6

In place of the stirring blade 2-71 of Example 2-1, the coagulation and/or precipitation-preventing means shown in FIG. 2-15 was used. More specifically, a piezoelectric transducer 2-84 (φ5) was placed in the ink tank 2-25 and the ink was dispersed by vibrating the piezoelectric transducer 2-84 using an oscillator 2-85 (ultrasonic disperser (Model UH-50) manufactured by Tokai Riki K.K.). Other than these, the same operation as in Example 2-1 was performed.

### Example 2-7

In place of the stirring blade 2-71 of Example 2-1, the re-stirring means shown in FIG. 2-16 was used. More specifically, a multistage vibrating blade (single axis type) was placed in the ink tank 2-25 and the ink was stirred with low frequency vibration by transmitting a low frequency from a vibrator 2-87 (supervibration α-stirrer manufactured by Nippon Techno K.K.) to the vibration blade 2-86. The stirring of Example 2-7 is not performed by the rotation of stirring blade as in Example 2-1 but performed using vibration of the stirring blade and therefore, air is not mingled into the ink. Furthermore, since the blade is not rotated, the blade can be provided in the most lateral end of the ink tank and the latitude of installation is broad. Other than these, the same operation as in Example 2-1 was performed.

In Comparative Examples, the same operation as in Examples 2-1 to 2-5 was performed except that the drawing was performed using no stirring/dispersing means. In any Example, the ejection became unstable within a few hours to a few days and after disorder of image or non-ejection state continued, the ejection port of the head was completely clogged with coarse semisolid aggregates of ink particles at the worst and the drawing could not be performed.

The coagulation and/or precipitation-preventing means for preventing coagulation/precipitation shown in Examples above, some of which are large-size equipment for the production line, are preferably downsized to an appropriate size according to the size of the ink tank and the required capacity and modified to enable the application to the plate-making apparatus of the present invention.

According to the present invention, a printing plate capable of printing a large number of printed matters having a clear image can be manufactured. Furthermore, a printing plate having a high-quality image directly responded to the digital image data can be stably manufactured and therefore, the lithographic printing can be performed at a low cost and at a high speed. In addition, coagulation of ink is prevented by the stirring/dispersing means, so that a printing plate having a high-quality image can be manufactured.

While the invention has been described in detail and with reference to specific embodiments thereof, it will be apparent to one skilled in the art that various changes and modifications can be made therein without departing from the spirit and scope thereof.

The entire disclosure of each and every foreign patent application from which the benefit of foreign priority has been claimed in the present application is incorporated herein by reference, as if fully set forth.

What is claimed is:

1. A plate-making method comprising:
forming an image directly on a plate material by an ink jet process of ejecting an oil ink using an electrostatic field based on signals of image data; and
fixing the image to prepare a printing plate,
wherein prevention of coagulation and/or precipitation of the oil ink particles is performed at least in a circulation of the oil ink.

2. An on-press drawing lithographic printing method comprising:
attaching a plate material onto a plate cylinder of a press;
forming an image directly on the plate material by an ink jet process of ejecting an oil ink from a recording head using an electrostatic field based on signals of image data to prepare a printing plate; and
performing lithographic printing using the printing plate in that state,
wherein prevention of coagulation and/or precipitation of the oil ink particles is performed at least in a circulation of the oil ink.

3. The plate-making method according to claim 1, wherein the oil ink comprises:
a nonaqueous solvent having an electric resistivity of 10⁹ Ωcm or more and a dielectric constant of 3.5 or less; and
resin particles dispersed in the nonaqueous solvent, the resin particles being solid and hydrophobic at least at an ordinary temperature.

4. The on-press drawing lithographic printing method according to claim 2, wherein the oil ink comprises:
a nonaqueous solvent having an electric resistivity of 10⁹ Ωcm or more and a dielectric constant of 3.5 or less; and
resin particles dispersed in the nonaqueous solvent, the resin particles being solid and hydrophobic at least at an ordinary temperature.

5. The plate-making method according to claim 1, wherein the prevention of coagulation and/or precipitation is performed before the ejection of the oil ink, and is to prevent a production of a bulked aggregate and/or a bulked precipitate of the oil ink.

6. The on-press drawing lithographic printing method according to claim 2, wherein the prevention of coagulation and/or precipitation is performed before the ejection of the oil ink, and is to prevent a production of a bulked aggregate and/or a bulked precipitate of the oil ink.

7. The plate-making method according to claim 1, wherein the prevention of coagulation and/or precipitation is performed by an operation comprising at least one of stirring, dispersion, mixing and jetting, and the stirring, dispersion, mixing and jetting operations are applied as a single operation, a plurality of operations or multiple operations.

8. The on-press drawing lithographic printing method according to claim 2, wherein the prevention of coagulation and/or precipitation is performed by an operation comprising at least one of stirring, dispersion, mixing and jetting, and the stirring, dispersion, mixing and jetting operations are applied as a single operation, a plurality of operations or multiple operations.

9. The plate-making method according to claim 7, wherein the at least one of stirring, dispersion, mixing and jetting is applied occasionally, periodically or continuously.

10. The on-press drawing lithographic printing method according to claim 8, wherein the at least one of stirring, dispersion, mixing and jetting is applied occasionally, periodically or continuously.

11. A plate-making apparatus comprising:
image-forming means forming an image directly on a plate material by an ink jet drawing device which ejects an oil ink from an ejection head using an electrostatic field based on signals of image data; and
image-fixing means fixing the image formed by the image-forming means to obtain a printing plate,
wherein at least one coagulation and/or precipitation-preventing means is provided on the flow path of the oil ink at least in a circulation of the oil ink.

12. An on-press drawing lithographic printing apparatus comprising:
image-forming means forming an image directly on a plate material attached to a plate cylinder of a press based on signals of image data, the image-forming means being an ink jet drawing device comprising a recording head which ejects an oil ink using an electrostatic field; and
lithographic printing means performing lithographic printing using a printing plate having thereon the image formed by the image-forming means,
wherein at least one coagulation and/or precipitation-preventing means is provided on the flow path of the oil ink at least in a circulation of the oil ink.

13. The plate-making apparatus according to claim 11, wherein the coagulation and/or precipitation-preventing means is provided at least immediately before the ink ejection part of the ejection head, and has a capacity of preventing a production of a bulked aggregate and/or a bulked precipitate of the oil ink at least in a circulation of the oil ink.

14. The on-press drawing lithographic printing apparatus according claim 12, wherein the coagulation and/or precipitation-preventing means is provided at least immediately before the ink ejection part of the recording head, and has a capacity of preventing a production of a bulked aggregate and/or a bulked precipitate of the oil ink at least in a circulation of the oil ink.

15. The plate-making apparatus according to claim 11, wherein the coagulation and/or precipitation-preventing means performs the prevention of coagulation and/or precipitation by an operation comprising at least one of stirring, dispersion, mixing and jetting, and the stirring, dispersion, mixing and jetting operations are applied as a single operation, a plurality of operations or multiple operations.

16. The on-press drawing lithographic printing apparatus according to claim 12, wherein the coagulation and/or precipitation-preventing means performs the prevention of coagulation and/or precipitation by an operation comprising at least one of stirring, dispersion, mixing and jetting, and the stirring, dispersion, mixing and jetting operations are applied as a single operation, a plurality of operations or multiple operations.

17. The plate-making apparatus as claimed in claim 11, wherein the at least one of stirring, dispersion, mixing and jetting is applied occasionally, periodically or continuously, and the coagulation and/or precipitation-preventing means is a cartridge type.

18. The on-press drawing lithographic printing apparatus according to claim 12, wherein the at least one of stirring, dispersion, mixing and jetting is applied occasionally, periodically or continuously, and the coagulation and/or precipitation-preventing means is a cartridge type.

19. The plate-making apparatus according to claim 11, wherein the oil ink comprises:
a nonaqueous solvent having an electric resistivity of 10⁹ Ωcm or more and a dielectric constant of 3.5 or less; and
resin particles dispersed in the nonaqueous solvent, the resin particles being solid and hydrophobic at least at an ordinary temperature.

20. The on-press drawing lithographic printing apparatus according to claim 12, wherein the oil ink comprises:
a nonaqueous solvent having an electric resistivity of 10⁹ Ωcm or more and a dielectric constant of 3.5 or less; and
resin particles dispersed in the nonaqueous solvent, the resin particles being solid and hydrophobic at least at an ordinary temperature.
